(19) United States
(12) Patent Application Publication
(10) Pub. No.: US 2026/0313191 A1
(43) Pub. Date: Oct. 8, 2026

(54) SOURCE DEVICE, DISPLAY DEVICE, AND OPERATING METHOD OF SOURCE DEVICE

(71) Applicant: SAMSUNG ELECTRONICS CO., LTD., Suwon-si (KR)

(72) Inventor: Seungho PARK, Suwon-si (KR)

(73) Assignee: SAMSUNG ELECTRONICS CO., LTD., Suwon-si (KR)

(21) Appl. No.: 19/462,524

(22) Filed: Jan. 28, 2026

Related U.S. Application Data
(63) Continuation of application No. PCT/KR2025/021144, filed on Dec. 9, 2025.

(30) Foreign Application Priority Data
Dec. 11, 2024 (KR) 10-2024-0184136

(51) Int. Cl. H04N 21/4363; H04N 21/433; H04N 21/44

(52) U.S. Cl. CPC H04N 21/4363; H04N 21/433; H04N 21/44

(57) ABSTRACT

Provided are a source device and a display device. The display device obtains first media data from a source device through a first transmission path, obtains, based on the first transmission path being lost, second media metadata for accessing second media data, requests, based on the second media metadata, the second media data from the source device, and obtains the second media data from the source device through a second transmission path that is different from the first transmission path.

### CROSS-REFERENCE TO RELATED APPLICATION(S)

This application is a bypass continuation of International Application No. PCT/KR2025/021144, filed on Dec. 9, 2025, which is based on and claims priority to Korean Patent Application No. 10-2024-0184136, filed on Dec. 11, 2024, the disclosures of which are incorporated by reference herein in their entireties.

### BACKGROUND

### 1. Filed

The disclosure relates to a source device, a display device, and an operating method of the source device.

### 2. Description of Related Art

Recently, wireless connection services for wirelessly connecting source devices that share screens to sink devices that receive screens have been studied. Source devices may be devices that generate or transmit content. Sink devices may be devices that are connected to source devices and receive content from and output content the source devices.

Source devices may receive various input signals, process the received input signals, and transmit content to display devices, which are an example of sink devices. Input signals may include video, audio, and additional information. Source devices may connect external source devices to themselves, process input signals, and transmit the processed input signals wirelessly to display devices. For example, a source device may receive a digital television (TV) (DTV) signal or analog TV (ATV) signal from a broadcast network, may digitize the received DTV or ATV signal, and may transmit the digitized DTV or ATV signal to a display device. Alternatively, for example, a source device may be connected to external source devices by wire, may receive input signals from the external source devices by wire, may process the received input signals, and may transmit the processed input signals wirelessly to a display device. Accordingly, source devices may transmit high-resolution video and audio data to display devices without high-definition multimedia interface (HDMI) cables or other wired connection interfaces, such as universal serial bus (USB).

Wireless connection services assume a stable wireless connection between source devices and display devices, and thus have a limitation that when the wireless connection becomes unstable or is lost in an actual usage environment, stable image viewing by users may not be ensured.

Advanced Television Systems Committee (ATSC) 3.0 is a North American next-generation digital TV broadcast standard having features such as a high data transmission rate and a network convergence service, and has been adopted as a domestic ultra-high definition (UHD) broadcast standard. ATSC 3.0 uses a real-time object delivery over unidirectional transport (ROUTE) protocol and an MPEG media transport (MMT) protocol as transmission standards. Users may watch over-the-air (OTA) content through a broadcast network.

Broadband IP channels refer to channels through which broadcast signals are transmitted via Internet protocol (IP), and represent a scheme of providing a broadcast service through a broadband Internet connection instead of a traditional broadcast network. Users have become able to watch content at a desired time through IPTV or an over-the-top (OTT) service.

### SUMMARY

According to an aspect of the disclosure, there is provided a source device including: an image receiver; a communicator; at least one processor including processing circuitry; and memory including one or more storage media storing one or more instructions, wherein the one or more instructions, when executed by the at least one processor individually or collectively, cause the source device to: transmit first media data obtained through the image receiver to a display device through a first transmission path; based on the first transmission path being lost, covert the first media data into second media data; store the second media data in a local web server; and transmit, according to a request from the display device, the second media data stored in the local web server to the display device through a second transmission path that is different from the first transmission path.

The first transmission path may include a path through which the first media data is transmitted via a first communication module comprising communication circuitry, configured to enable direct communication between the source device and the display device, and the second transmission path may include a path through which the second media data is transmitted via a second communication module comprising communication circuitry, configured to enable communication between the source device and the display device through a broadband network.

The first media data may include data based on a first communication protocol that is a standard available in a broadcast network, and wherein the second media data may include data based on a second communication protocol that is a standard available in the broadband network.

The one or more instructions, when executed by the at least one processor individually or collectively, may cause the source device to: extract, based on the first transmission path being lost, one or more media files included in the first media data standardized according to a first communication protocol; and generate the second media data by standardizing the one or more media files according to a second communication protocol that is different from the first communication protocol.

The second media data may include one or more segments, and wherein the one or more instructions, when executed by the at least one processor individually or collectively, may cause the source device to: obtain a segment request from the display device by using a uniform resource locator (URL) including segment availability start time information and location information of the local web server; and transmit, based on the segment request, a segment corresponding to the segment availability start time information, from among the one or more segments, to the display device through the second transmission path.

The segment availability start time information corresponds to a time point when the first transmission path is lost, and wherein the segment corresponding to the segment availability start time information corresponds to a segment generated by the source device at the time point when the first transmission path is lost.

The one or more instructions, when executed by the at least one processor individually or collectively, may cause the source device to, based on the first transmission path being recovered, transmit the first media data to the display device through the first transmission path.

According to an aspect of the disclosure, there is provided a display device including: a communicator; at least one processor including processing circuitry; and memory including one or more storage media storing one or more instructions, wherein the one or more instructions, when executed by the at least one processor individually or collectively, cause the display device to: obtain first media data from a source device through a first transmission path; based on the first transmission path being lost, obtain second media metadata for accessing second media data; request, based on the second media metadata, the second media data from the source device; and obtain the second media data from the source device through a second transmission path that is different from the first transmission path.

The first transmission path may include a path through which the first media data is obtained via a first communication module configured to enable direct communication between the source device and the display device, and wherein the second transmission path may include a path through which the second media data is obtained via a second communication module configured to enable communication between the source device and the display device through a broadband network.

The first media data may include data based on a first communication protocol that is a standard available in a broadcast network, and wherein the second media data may include data based on a second communication protocol that is a standard available in the broadband network.

The one or more instructions, when executed by the at least one processor individually or collectively, may cause the display device to generate the second media metadata may include location information of a local web server of the source device and segment availability start time information.

The second media data may include one or more segments, and wherein the one or more instructions, when executed by the at least one processor individually or collectively, may cause the display device to: transmit a segment request to the source device by using a uniform resource locator (URL) including the segment availability start time information and the location information of the local web server; and obtain, based on the segment request, a segment corresponding to the segment availability start time information from the source device through the second transmission path.

The segment availability start time information corresponds to a time point when the first transmission path is lost, and wherein the segment corresponding to the segment availability start time information corresponds to a segment stored in the local web server at the time point when the first transmission path is lost.

The one or more instructions, when executed by the at least one processor individually or collectively, may cause the display device to: based on obtaining the first media data, extract a video stream by parsing a packet packetized according to the first communication protocol corresponding to the first media data; and based on obtaining the second media data, extract a video stream by parsing a packet packetized according to the second communication protocol corresponding to the second media data.

The one or more instructions, when executed by the at least one processor individually or collectively, may cause the display device to obtain, based on the first transmission path being recovered, the first media data from the source device through the first transmission path.

According to an aspect of the disclosure, there is provided an operating method of a source device, the operating method including: transmitting first media data obtained through an image receiver to a display device through a first transmission path; converting, based on the first transmission path being lost, the first media data into second media data; storing the second media data in a local web server; and transmitting, based on a request from the display device, the second media data stored in the local web server to the display device through a second transmission path that is different from the first transmission path.

The first transmission path may include a path through which the first media data is transmitted via a first communication module configured to enable direct communication between the source device and the display device, and wherein the second transmission path may include a path through which the second media data is transmitted via a second communication module configured to enable communication between the source device and the display device through a broadband network.

The converting of the first media data into the second media data may include: extracting, based on the first transmission path being lost, one or more media files included in the first media data standardized according to a first communication protocol; and generating the second media data by standardizing the one or more media files according to a second communication protocol that is different from the first communication protocol.

The second media data may include one or more segments, and wherein the providing of the second media data to the display device through the second transmission path may include: obtaining a segment request from the display device by using a uniform resource locator (URL) including segment availability start time information and location information of the local web server; and providing, based on the segment request, a segment corresponding to the segment availability start time information, from among the one or more segments, to the display device through the second transmission path.

According to an aspect of the disclosure, there is provided a non-transitory computer-readable recording medium having recorded thereon a program for performing, on a computer, an operating method of a source device, the operating method including: transmitting first media data obtained through an image receiver to a display device through a first transmission path; converting, based on the first transmission path being lost, the first media data into second media data; storing the second media data in a local web server; and transmitting, based on a request from the display device, the second media data stored in the local web server to the display device through a second transmission path that is different from the first transmission path.

### BRIEF DESCRIPTION OF THE DRAWINGS

The disclosure may be readily understood by a combination of the following detailed description and the accompanying drawings, wherein reference numerals denote structural elements, in which:

FIG. 1 is a schematic diagram of a system including a source device and a display device, according to an embodiment of the disclosure;

FIG. 2 is a diagram of an Advanced Television Systems Committee (ATSC) 3.0 protocol stack;

FIG. 3 is a block diagram of a source device and a display device according to an embodiment of the disclosure;

FIG. 4 is a flowchart for describing an operating method of a source device, according to an embodiment of the disclosure;

FIG. 5 is a flowchart for describing an operating method of a display device, according to an embodiment of the disclosure;

FIG. 6 is a flowchart for describing operating methods of a source device and a display device that are connected to each other through a first transmission path and a second transmission path, according to an embodiment of the disclosure;

FIG. 7 is a diagram for describing operations of a source device and a display device that are connected to each other through a first transmission path, according to an embodiment of the disclosure;

FIG. 8 is a diagram for describing an operation of a first demuxer of FIG. 7;

FIG. 9 is a diagram for describing operations of a source device and a display device that are connected to each other through a second transmission path, according to an embodiment of the disclosure;

FIG. 10A is a diagram for describing an operation of a second demuxer of FIG. 9;

FIG. 10B is a diagram for describing an operation of a packetizer of FIG. 9;

FIG. 11 is a diagram for describing a second media data playback process between a source device and a display device, according to an embodiment of the disclosure;

FIG. 12 is a diagram for describing a screen of content output to a display device in various scenarios, according to an embodiment of the disclosure; and

FIG. 13 is a detailed block diagram of a display device according to an embodiment of the disclosure.

### DETAILED DESCRIPTION

Herein, the expression "at least one of a, b, or c" may indicate only a, only b, only c, both a and b, both a and c, both b and c, all of a, b, and c, or variations thereof.

Hereinafter, embodiments of the disclosure will be described in detail with reference to the accompanying drawings so that the embodiments of the disclosure may be easily implemented by one of ordinary skill in the art. However, the disclosure may be embodied in many different forms and is not limited to the embodiments of the disclosure set forth herein.

Terms used in the disclosure are described as general terms currently used in consideration of functions described in the disclosure, but the terms may have different meanings according to the intention of one of ordinary skill in the art, precedent cases, or the appearance of new technologies. Accordingly, the terms used herein should be defined not based on the names thereof, but based on the meanings thereof and the whole context of the disclosure.

Also, the terms used herein are for the purpose of describing a particular embodiment of the disclosure only, and are not intended to be limiting of the disclosure.

Throughout the disclosure, when a part is "connected" to another part, the part may not only be "directly connected" to the other part, but may also be "electrically connected" to the other part with another element in between.

In the disclosure, and particularly in the claims, "the" and similar referents may be used to indicate both singular and plural forms. Also, when there is no description explicitly specifying an order of operations of a method according to the disclosure, the operations may be performed in an appropriate order. The disclosure is not, however, limited to the described order of the operations.

Expressions such as "in some embodiments" and "in an embodiment" mentioned throughout the disclosure are not intended to indicate the same embodiment.

Some embodiments of the disclosure may be represented by functional block configurations and various processing operations. Some or all of the functional blocks may be implemented by various numbers of hardware and/or software configurations for performing certain functions. For example, the functional blocks of the disclosure may be implemented by one or more microprocessors or by circuit configurations for a certain function. Also, for example, the functional blocks of the disclosure may be implemented in various programming or scripting languages. The functional blocks may be implemented in algorithms executed on one or more processors. Also, the disclosure may employ general techniques for electronic environment setting, signal processing, and/or data processing. Terms such as "mechanism," "element," "means," and "configuration" may be used widely and are not limited as mechanical and physical configurations.

Also, lines or members connecting components illustrated in the drawings are merely illustrative of functional connections and/or physical or circuit connections. In an actual device, connections between components may be represented by various functional connections, physical connections, or circuit connections that are replaceable or added.

Also, terms such as "… unit" and "… module" used in the disclosure indicate a unit for processing at least one function or operation, and the unit and the module may be implemented in hardware, software, or in a combination of hardware and software.

In the disclosure, the term "processor" may include various processing circuits and/or a plurality of processors. For example, the term "processor" as used herein, including in the claims, may include various types of processing circuitry including at least one processor. The at least one processor may be configured to individually and/or collectively perform various functions described herein in a distributed manner. As used herein, "processor," "at least one processor," or "one or more processors" may be configured to perform various functions. However, such terms cover, without limitation, situations where one processor performs some functions and other processor(s) perform some other functions, and situations where a single processor may perform all functions. Also, the at least one processor may include a combination of processors that perform various functions described herein in a distributed manner. The at least one processor may execute program instructions to achieve or perform the various functions.

In the disclosure, the term "user" may refer to a person using a display device, and may include a consumer, an evaluator, a viewer, an administrator, or an installation technician. Also, the term "manufacturer" or "provider" may refer to a manufacturer that produces a display device and/or components included in the display device.

In the disclosure, the term "image" may include a still image, a graphic, a picture, a frame, a moving image including a plurality of consecutive still images, or a video.

In this disclosure, the term "transmission path" may refer to a physical or logical path through which data moves from a transmitting device to a receiving device. For example, a transmission path may refer to a routing path over a network, or a physical network connection. For example, in a wireless fidelity (Wi-Fi) direct (WFD) connection, a transmission path may refer to a wireless communication path between two devices. Alternatively, for example, in a device-to-device connection relayed by an access point (AP), a transmission path may refer to a physical connection path or a wireless communication path between two devices.

In the disclosure, the term "pipeline" may refer to a series of processes for processing and transmitting data. For example, a process in which a source device packetizes received data and transmits the packetized data to a display device through a network may be implemented as a pipeline. Also, for example, a process in which a display device performs image processing on received data may be implemented as a pipeline.

In the disclosure, the term "decapsulation," "depacketization," "demuxing," or "demultiplexing" may refer to an operation of extracting data contained within a packet by analyzing (or parsing) information included in a header of the packet, or an operation of separating data, such as video, audio, and subtitles, included in one transmission stream.

In the disclosure, the term "streaming data" refers to a continuous data flow generated from various sources. A streaming server may divide streaming data into small media file fragments, and may transmit the media file fragments to a client. For example, each media file may be stored in a fragmented MP4 format, but is not limited thereto. Each media file may be decoded independently.

In the disclosure, the term "broadband Internet protocol (IP) server" refers to a computer device that transmits data through a broadband (Internet network) based on a request received from a client.

In the disclosure, the term "local web server" refers to a computer device that provides a service to a client within a local network. A local web server may be used within an internal network or the same network, and may provide content by responding to a client request through a hypertext transfer protocol (HTTP). In the disclosure, the term “local network” refers to a communication network distinguished from the Internet network, in which a plurality of devices on the same network can directly communicate with each other without routing. For example, the source device and the display device being connected to a local network may indicates that the two devices exist on the same local network and can directly communicate with each other without routing.

In the disclosure, content may be received by a device from a content provider, such as a broadcast signal, a streaming service, a Blu-ray player, or a game console. Content may include one or more of broadcast content received directly from a broadcasting station as a radio frequency (RF) signal, broadcast content received through an external source device, and content received from a content providing server through the Internet.

Hereinafter, the disclosure will be described in detail with reference to the accompanying drawings.

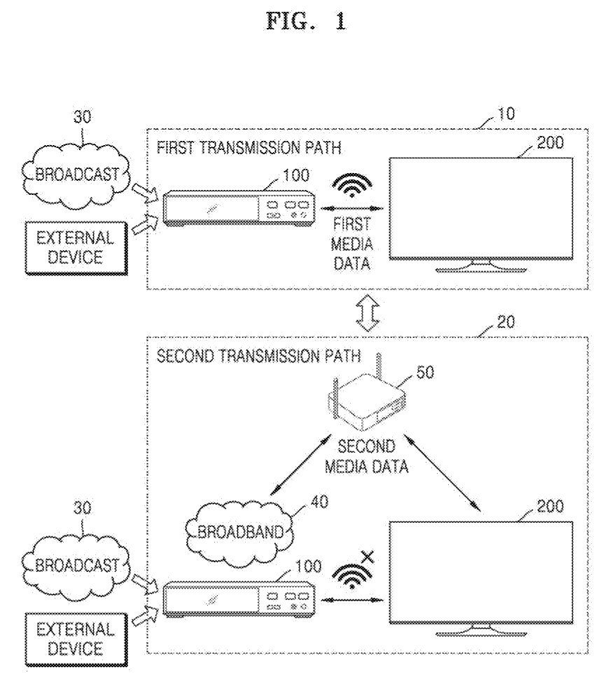

FIG. 1 is a schematic diagram of a system including a source device and a display device, according to an embodiment of the disclosure.

A system according to an embodiment of the disclosure may include a source device 100 and a display device 200. The system may include devices that provide a wireless connection service between the source device 100 and the display device 200. Here, the display device 200 may be a sink device. The source device 100 and the display device 200 may be wirelessly connected to each other, the source device 100 may transmit (or provide), to the display device 200, various content received (or obtained) from an external device, and the display device 200 may output the content received from the source device 100.

The source device 100 according to an embodiment of the disclosure may include a set-top box, a Blu-ray disk player, a digital versatile disk (DVD) player, a game device, a digital camera, a camcorder, a streaming device, and a home theater. Alternatively, the source device 100 may include various electronic devices, such as a smartphone, a tablet personal computer (PC), a mobile terminal, a video phone, an e-book reader, a desktop PC, a laptop PC, a netbook computer, a personal digital assistant (PDA), a portable multimedia player (PMP), a navigation, an MP3 player, and a wearable device.

The display device 200 according to an embodiment of the disclosure may be a television (TV), but this is merely an example, and the display device 200 may be implemented as an electronic device capable of receiving a broadcast signal and displaying an image based on the broadcast signal. For example, the display device 200 may be implemented as various electronic devices, such as a mobile phone, a tablet PC, a digital camera, a camcorder, a laptop computer, a tablet PC, a desktop, an e-book reader, a digital broadcasting terminal, a PDA, a PMP, a navigation, an MP3 player, and a wearable device. In particular, embodiments of the disclosure may be easily implemented in a display device with a large display, such as a TV, but are not limited thereto.

Also, the display device 200 may be stationary or mobile, and may be a digital broadcast receiver capable of receiving a digital broadcast. Also, the display device 200 may be implemented not only as a flat display device, but also as a curved display device having a curved screen, or a flexible display device having an adjustable curvature. An output resolution of the source device 100 may include, for example, high definition (HD), full HD, ultra HD, or a resolution clearer than ultra HD.

The source device 100 according to an embodiment of the disclosure may receive various content from an external device. For example, the content may refer to multimedia content, and may include an image, video, audio, text, a game, an application, and a broadcast, but is not limited thereto. For example, the source device 100 may receive broadcast content from a broadcast network 30 through a tuner unit. The broadcast content may include media in various forms, including a collection of media components (e.g., video, audio, subtitles, and service announcements) provided to a user. For example, the source device 100 may receive various content from an external device through an input/output unit. For example, the source device 100 may receive, through a communicator, content from an external server or various applications, for example, an over-the-top (OTT) service provider.

The source device 100 according to an embodiment of the disclosure may be connected to the display device 200 through a communication network. The source device 100 may transmit the received content to the display device 200. The display device 200 may receive content from the source device 100, and may output the received content through a display.

The source device 100 and the display device 200 according to an embodiment of the disclosure may be connected to each other through a first transmission path 10 or a second transmission path 20, depending on the network environment. For example, when the network environment supporting the first transmission path 10 is stable, the source device 100 may transmit first media data to the display device 200 through the first transmission path 10. The display device 200 may receive the first media data from the source device 100 through the first transmission path 10. In contrast, when the network environment supporting the first transmission path 10 is unstable or the first transmission path 10 is lost, the source device 100 may transmit second media data to the display device 200 through the second transmission path 20. The display device 200 may receive the second media data from the source device 100 through the second transmission path 20.

The first transmission path 10 and the second transmission path 20 according to an embodiment of the disclosure may be different paths that are connected to the source device 100 and the display device 200 through different communication networks. The first transmission path 10 according to an embodiment of the disclosure may be a path through which the first media data is transmitted via a first communication module (or communication interface) (e.g., comprising communication circuity) that enables direct communication between the source device 100 and the display device 200. For example, the source device 100 and the display device 200 may be connected to each other through short-range wireless communication, such as wireless LAN (WLAN) (e.g., Wi-Fi). The second transmission path 20 according to an embodiment of the disclosure may be a path through which the second media data is transmitted via a second communication module (or communication interface) (e.g., comprising communication circuity) that enables communication between the source device 100 and the display device 200 through an AP 50. For example, each of the source device 100 and the display device 200 may access a broadband network 40 through the AP 50, so as to be indirectly connected to each other.

The first media data and the second media data according to an embodiment of the disclosure may be the same content, which is standardized (or formatted) according to different communication protocols and transmitted through different transmission paths. For example, the first media data may be data transmitted through the first transmission path 10, and the second media data may be data in which content included in the first media data is transmitted through the second transmission path 20.

For example, the first media data may be data standardized according to a first communication protocol corresponding to a reception scheme of content received by the source device 100 from an external device. For example, when the content received by the source device 100 is broadcast content received through the broadcast network 30, the first media data may be data standardized according to the first communication protocol available in the broadcast network 30. The first media data may be transmitted from the source device 100 to the display device 200 through the first transmission path 10 in a state of being standardized according to the first communication protocol (e.g., a broadcast protocol) available in the broadcast network 30. For example, the second media data may be data standardized according to a second communication protocol (e.g., IP) that is a standard available in the broadband network 40. The second media data may be obtained by converting the format of the first media data into the format of the second media data so that the first media data received through the broadcast network 30 may be transmitted through the broadband network 40.

In an embodiment of the disclosure, while the first transmission path 10 is maintained, the source device 100 may transmit the first media data, which is standardized according to the first communication protocol available in the broadcast network 30, to the display device 200 through the first transmission path 10, without separate processing of the first media data. In an embodiment of the disclosure, while the first transmission path 10 is lost, the source device 100 may generate second media data by converting the format of a media file included in the first media data into the second communication protocol, so that the first media data may be transmitted through the broadband network 40, and may transmit the second media data to the display device 200 through the second transmission path 20.

The source device 100 according to an embodiment of the disclosure may establish a local web server within the source device 100 to transmit the second media data through the second transmission path 20, and may itself operate as a broadband IP server. Also, the display device 200 may request the second media data from the source device 100 through the second transmission path 20, and may operate as a web client to receive the second media data.

A web server-web client structure is a structure in which, when the web server remotely receives an HTTP request from the web client through the broadband network 40, the web server transmits, in response to the HTTP request, data corresponding to an HTTP response to the web client.

In an embodiment of the disclosure, the source device 100 establishing a local web server and operating as a broadband IP server may indicate that the source device 100 establishes a local web server at a local host address thereof (e.g., 127.0.0.1) and, when receiving a request from a web client (e.g., the display device 200), transmits a response to the web client. In an embodiment of the disclosure, the display device 200 operating as a web client may indicate that the display device 200 is connected to the same network as the source device 100 and accesses the local web server of the source device 100 by using a uniform resource locator (URL) including the local host address of the source device 100 (e.g., 127.0.0.1). The display device 200 may request data from the source device 100 by using the URL, and may receive the data from the source device 100.

The source device 100 according to an embodiment of the disclosure may extract segments included in the first media data standardized according to the first communication protocol, may generate second media data by standardizing the extracted segments according to the second communication protocol, and may store the second media data in a local web server.

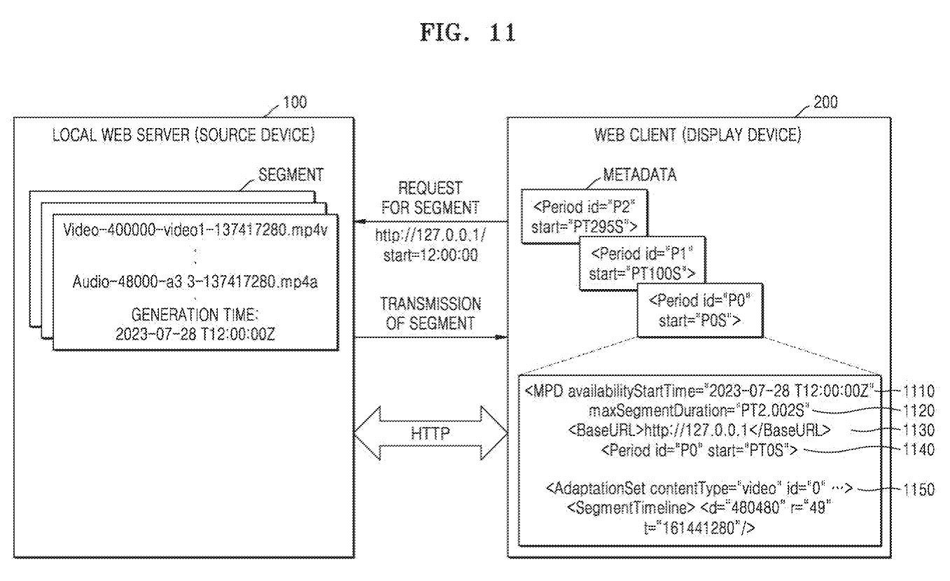

The display device 200 according to an embodiment of the disclosure may access the local web server to obtain second media metadata including information for requesting segments included in the second media data. The second media metadata may include bibliographic information about the segments included in the second media data. For example, the second media metadata may include the local host address of the source device 100 (e.g., 127.0.0.1), a content type of each segment, a length of each segment, and an availability start time of each segment. The display device 200 may generate, based on the second media metadata, a URL including a local host address and a segment file name, may request segments from the local web server by using the URL, and may receive the segments from the local web server. Here, the segment file name may include segment availability start time information, which will be described in detail with reference to FIG. 11. The second media metadata may be referred to as a "media presentation description (MPD) file."

When the source device 100 and the display device 200 according to an embodiment of the disclosure are connected to each other through the first transmission path 10, the source device 100 may directly transmit the first media data to the display device 200, based on the first transmission path 10, thereby enabling fast and stable transmission of large-capacity media data.

When the first transmission path 10 connected to the source device 100 and the display device 200 according to an embodiment of the disclosure is lost, the source device 100 and the display device 200 may switch the transmission path to the second transmission path 20, which is connected to the source device 100 and the display device 200 through the broadband network 40. When the first transmission path 10 is lost, the source device 100 may operate as a broadband IP server, the display device 200 may operate as a web client, and content may be transmitted content through the second transmission path 20. Accordingly, even when direct communication between the source device 100 and the display device 200 is unstable, data transmission between the source device 100 and the display device 200 may not be interrupted, thereby ensuring stable image viewing by the user.

Meanwhile, in the disclosure, the first communication protocol is described as a broadcast protocol, but is not limited thereto. For example, when the content received by the source device 100 is content received from an external device through a high-definition multimedia interface (HDMI) port, the first media data may be data standardized according to the HDMI standard. Also, for example, when the content received by the source device 100 is OTT content received through the communicator, the first media data may be data standardized to format the OTT content.

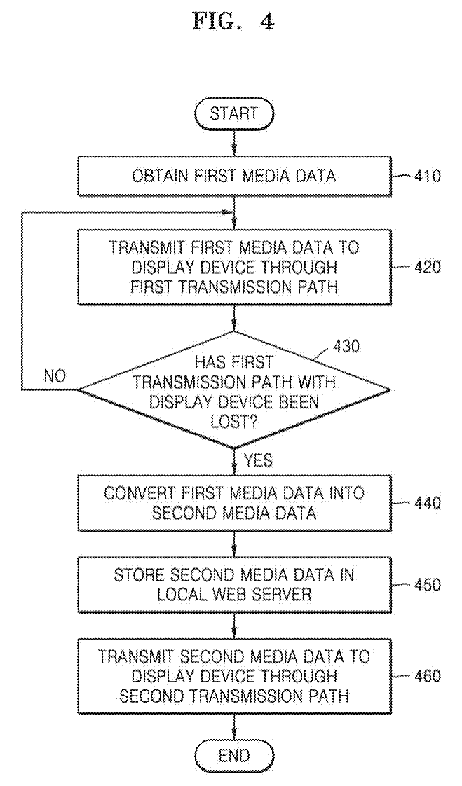

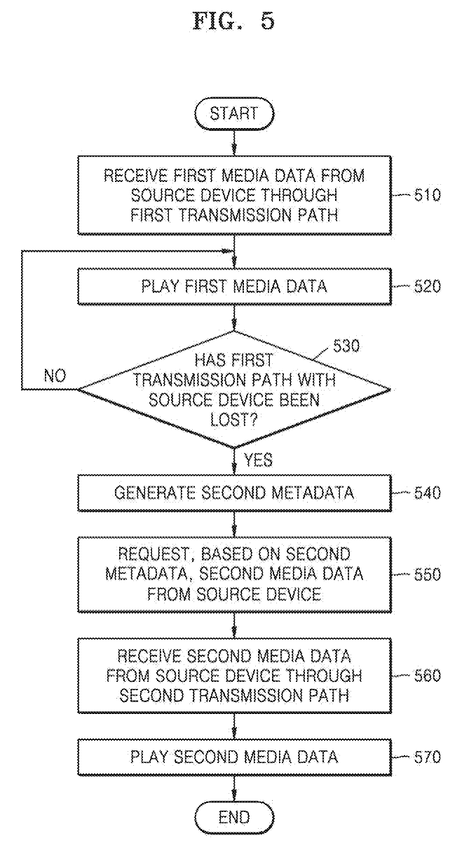

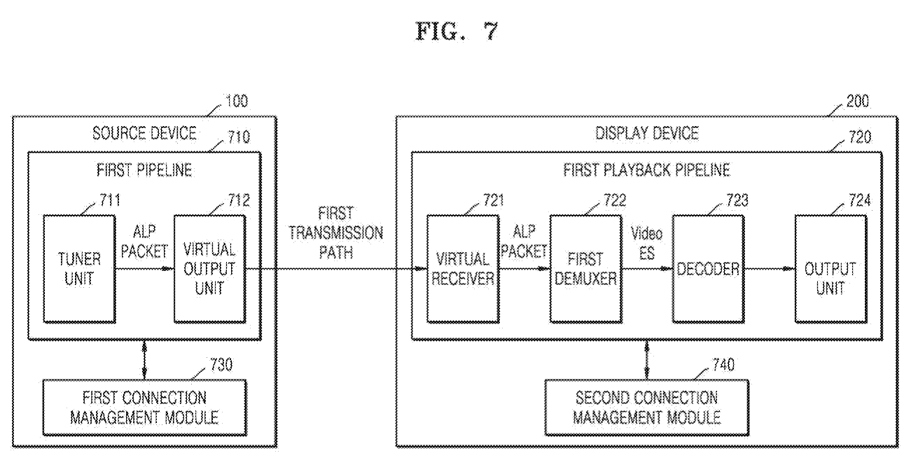

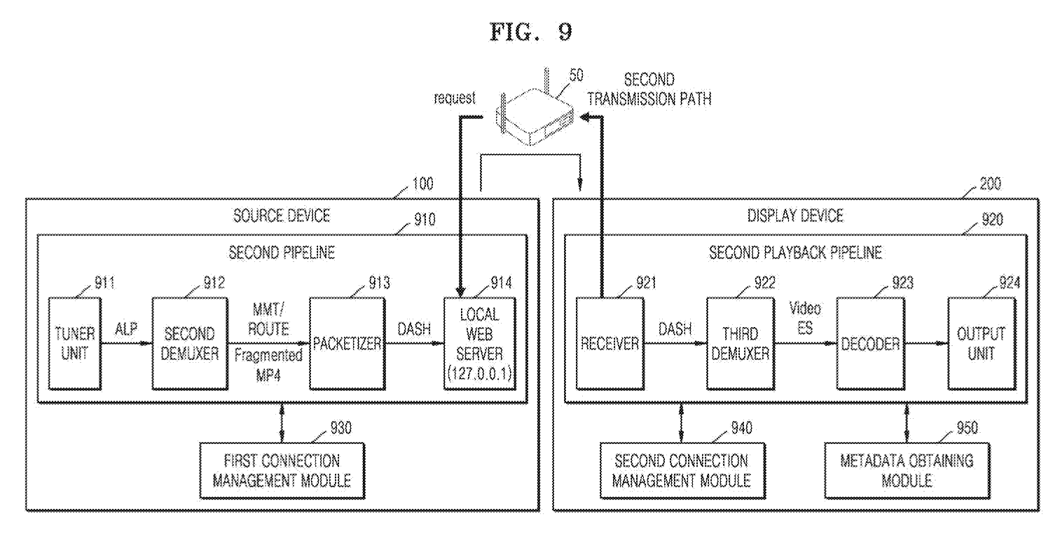

Meanwhile, in an embodiment of the disclosure, each of the source device 100 and the display device 200 may identify whether the first transmission path 10 has been lost. This aspect will be described with reference to operation 430 of FIG. 4 regarding an operating method of the source device 100, and operation 530 of FIG. 5 regarding an operating method of the display device 200. Also, a first connection management module (730 of FIG. 7 or 930 of FIG. 9) of the source device 100 and a second connection management module (740 of FIG. 7 or 940 of FIG. 9) of the display device 200 will be described. However, an embodiment of the disclosure is not limited thereto, and at least one of the source device 100 or the display device 200 may identify whether the first transmission path 10 has been lost.

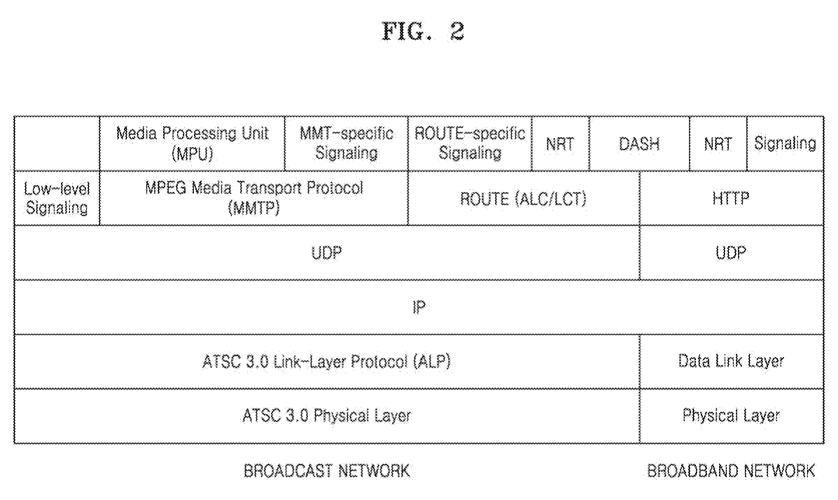

FIG. 2 is a diagram of an Advanced Television Systems Committee (ATSC) 3.0 protocol stack.

Referring to FIG. 2, a scheme of transmitting content through a broadcast network may include a scheme of transmitting media processing units (MPUs) by using an MPEG media transport (MMT) protocol (or MMT protocol (MMTP)) and a scheme of transmitting MPEG-dynamic adaptive streaming over HTTP (DASH) segments by using a real-time object delivery over unidirectional transport (ROUTE) protocol. A user datagram protocol (UDP)/IP-based MMT protocol or ROUTE protocol may be used in the broadcast network.

For example, at a transmitter, MMTP may transmit data formatted in an MPU format and MMT-specific signaling information. The data may be encapsulated in a UDP format at a transport layer, and may be encapsulated into an IP packet at a network layer. Also, for example, at the transmitter, ROUTE may transmit data formatted in a DASH segment format and ROUTE-specific signaling information. The data may be encapsulated in a UDP format, and may be encapsulated into an IP packet. Here, the signaling information may be signaling information about a service. The IP/UDP packet may be encapsulated again at a link layer, and the encapsulated IP/UDP packet may be referred to as an "ATSC link-layer protocol (ALP) packet." The ALP packet may be transmitted to a physical layer, and may be transmitted to a network layer of a receiver. At the receiver, decapsulation (or demuxing, depacketization, or parsing) of data may be performed sequentially from a link layer to a transport layer.

A scheme of transmitting content through a broadband network may include a scheme of transmitting MPEG-DASH segments of an HTTP/transmission control protocol (TCP)/IP protocol standard. A TCP/IP-based HTTP protocol may be used in the broadband network.

For example, at a transmitter, data in a DASH segment format may be encapsulated in the form of an HTTP message, may be divided into TCP segment units at a transport layer, and may be encapsulated into an IP packet at a network layer. Media data transmitted through the broadband network may be used in communication between a web server and a web client. For example, when receiving an HTTP request from the web client, the web server may transmit MPEG-DASH segments in an HTTP response. Each segment may be distinguished by a transmitter port number, a receiver port number, and a segment order. The segment order may be distinguished by an index or a time stamp. Accordingly, the media data may not be lost or out of order.

The first media data according to an embodiment of the disclosure may correspond to over-the-air (OTA) streaming data received through a broadcast network. The OTA streaming data may be transmitted in a form in which content is divided into media file fragments in an MPU format or a DASH segment format. That is, the unit of a media file may be an MPU format or a DASH segment format. The first media data may be generated in an MPU format and MMT-packetized, or may be generated in a DASH segment format and ROUTE-packetized. The first communication protocol may include an MMT/UDP/IP or ROUTE/UDP/IP protocol according to the ATSC 3.0 standard.

The second media data according to an embodiment of the disclosure may correspond to over-the-top (OTT) streaming data that may be transmitted through a broadband network. The OTT streaming data may be transmitted in a form in which content is divided into media file fragments in a DASH segment format. That is, the unit of a media file may be a DASH segment format. The second media data may be generated in a DASH segment format and packetized based on HTTP. The second communication protocol may include an HTTP/TCP/IP protocol.

In an embodiment of the disclosure, when the first transmission path is lost, the source device 100 may convert a broadcast protocol, such as MMT or ROUTE (hereinafter referred to as "MMT/ROUTE"), into an Internet protocol, such as HTTP-based MPEG-DASH. In this case, the second media data may retain media file fragments included in the first media data, but may be converted in format (e.g., in length and structure) to conform to the DASH specification.

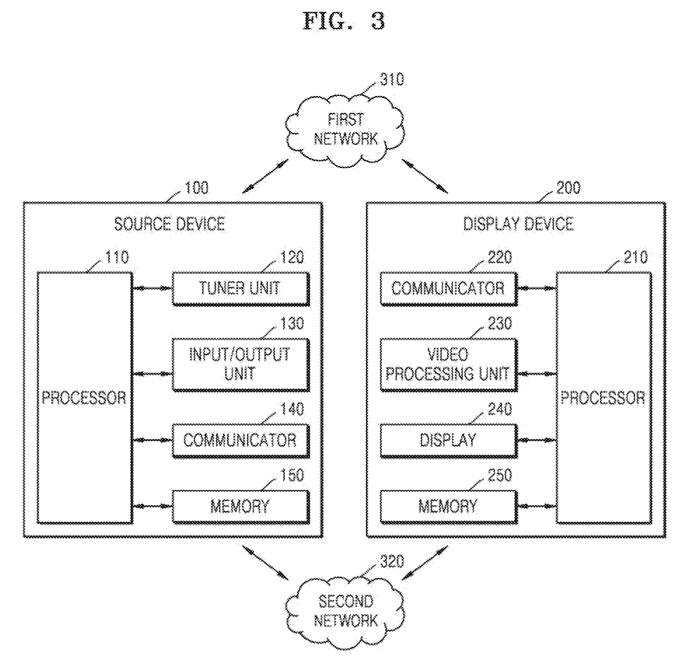

FIG. 3 is a block diagram of a source device and a display device according to an embodiment of the disclosure.

Referring to FIG. 3, a system according to an embodiment of the disclosure may include the source device 100, the display device 200, a first network 310 connecting the source device 100 and the display device 200 to each other, and a second network 320 connecting the source device 100 and the display device 200 to a broadband network.

The first network 310 may be a short-range communication network that enables communication between the source device 100 and the display device 200 in a short distance, and may use, for example, WLAN (or Wi-Fi), Bluetooth, Bluetooth low energy (BLE), soft AP, near-field communication (NFC), or WFD. The term "soft AP" stands for "software enabled access point," and refers to software that enables a computer other than a router to act as a wireless AP. The first network 310 may support a first transmission path connected to the source device 100 and the display device 200 through a first communication module provided in the source device 100 and a first communication module provided in the display device 200. For example, the first network 310 may be Wi-Fi 7 that enables wireless communication with an external device through different frequency bands (e.g., a 2.4 GHz band, a 5 GHz band, and a 6 GHz band) and channels through multi-link operation (MLO) technology, but is not limited thereto.

The second network 320 may include a WLAN communication network (or Wi-Fi communication network) for connecting each of the source device 100 and the display device 200 to the broadband network. The second network 320 may support a second transmission path connected to the source device 100 and the display device 200 through a second communication module provided in the source device 100 and a second communication module provided in the display device 200. In the disclosure, the second network 320 is illustrated as being formed through an AP, but is not limited thereto. For example, the second network 320 may be replaced not only with an AP, but also with various unspecified communication technologies that are different from the first network 310.

However, an embodiment of the disclosure is not limited thereto, and the source device 100 and the display device 200 may be connected to each other by wire through an HDMI port, a mobile high-definition link (MHL) port, a universal serial bus (USB) port, a display port (DP), a Thunderbolt port, a video graphics array (VGA) port, an RGB port, a D-subminiature (D-sub), a digital visual interface (DVI), a component jack, or a PC port.

First, the source device 100 will be described.

The source device 100 according to an embodiment of the disclosure may include a processor 110, a tuner unit 120, an input/output unit 130, a communicator 140, and memory 150. However, not all of the illustrated components are essential. The source device 100 may be implemented with more components than the illustrated components, or may be implemented with fewer components. In an embodiment of the disclosure, the source device 100 may receive content through at least one of the tuner unit 120, the input/output unit 130, or the communicator 140, each of which may be referred to as an "image receiver."

The tuner unit 120 may tune and select only a frequency of a desired channel to be received by the source device 100 from among multiple radio wave components through amplification, mixing, or resonance of broadcast content received by wire or wirelessly. The content received through the tuner unit 120 may be demuxed and decoded by the display device 200, which will be described below, and may be separated into video, audio, and/or additional information (e.g., an electronic service guide (ESG)). The separated video, audio, and/or additional information may be stored in memory 250 of the display device 200.

In an embodiment of the disclosure, the tuner unit 120 may include a tuner and a demodulator. The tuner unit 120 may receive an RF signal from a broadcast network through the tuner, and may demodulate the RF signal through the demodulator to obtain first media data, which is digital data. The first media data obtained through the tuner unit 120 may be transmitted to the display device 200 through the first transmission path without separate processing.

The input/output unit 130 may receive, under control by the processor 110, video (e.g., a dynamic image signal or a still image signal), audio (e.g., a voice signal or a music signal), and additional information from an external device. The input/output unit 130 may include at least one of an HDMI port, a component jack, a PC port, or a USB port. In addition, the input/output unit 130 may further include a DP, a Thunderbolt port, and an MHL port. The input/output unit 130 may further include ports for separate output of video and audio.

In an embodiment of the disclosure, the input/output unit 130 may receive first media data from an external device. The first media data received through the input/output unit 130 may be transmitted to the display device 200 through the first transmission path without separate processing.

The communicator 140 may connect, under control by the processor 110, the source device 100 to a peripheral device, an external device, a server, or a mobile terminal. The communicator 140 may include various communication circuits included in at least one communication module. The communicator 140 may include a short-range communication module, a wireless Internet module, or a wired Ethernet, in accordance with the performance and structure of the source device 100.

The short-range communication module may be a module for short-range communication, and may include a WLAN module (Wi-Fi module), a Bluetooth module, a Zigbee module, an infrared data association (IrDA) module, and a WFD module, but is not limited thereto. The WLAN module may transmit/receive a Wi-Fi signal to/from a peripheral device according to the Wi-Fi communication standard. The Bluetooth module may receive a Bluetooth signal transmitted from a peripheral device, according to the Bluetooth communication standard. The WFD module may support peer-to-peer (P2P) communication, which enables direct connection between two devices without an AP. Wi-Fi may use a frequency of a 2.4 GHz band, a 5 GHz band, or a 6 GHz band. The short-range communication module may be used to communicate with the display device 200.

The wireless Internet module may be a module for wireless Internet access, and may be built into or external to a device. The wireless Internet module may include a WLAN module and a wireless broadband (Wibro) module. The wireless Internet module may be used to enable the source device 100 to communicate with a server device. The WLAN module may be used as a wireless Internet module when connecting to the Internet through an AP.

The first communication module of the source device 100 according to an embodiment of the disclosure may include a short-range communication module. The second communication module of the source device 100 according to an embodiment of the disclosure may include a wireless Internet module.

In an embodiment of the disclosure, the communicator 140 may receive first media data from an external device. The first media data received through the communicator 140 may be transmitted to the display device 200 through the first transmission path without separate processing.

The processor 110 may be electrically connected to the components included in the source device 100, and may execute computation or data processing related to control and/or communication of the components included in the source device 100. In an embodiment of the disclosure, the processor 110 may load a request, a command, or data received from at least one of the other components into memory, may process the loaded request, command, or data, and may store processing result data in the memory. According to an embodiment of the disclosure, the processor 110 may include at least one of a general-purpose processor, such as a central processing unit (CPU), an application processor (AP), or a digital signal processor (DSP), a graphics-only processor, such as a graphics processing unit (GPU) or a vision processing unit (VPU), or an artificial intelligence-only processor, such as a neural processing unit (NPU).

The processor 110 may process input data or control the other components to process the input data, according to data, an operating rule, an algorithm, a method, or a model stored in the memory 150. The processor 110 may use the input data to perform an operation of a pre-defined operating rule, algorithm, method, or model stored in the memory 150.

The memory 150 may be electrically connected to the processor 110, and may store one or more modules, algorithms, operating rules, models, programs, instructions, or pieces of data related to operations of the components included in the source device 100. For example, the memory 150 may store one or more modules, algorithms, operating rules, models, programs, instructions, or pieces of data for processing and controlling by the processor 110. The memory 150 may include at least one type of storage medium from among a flash memory type, a hard disk type, a multimedia card micro type, a card type memory (e.g., a secure digital (SD) or extreme digital (XD) memory), random-access memory (RAM), static RAM (SRAM), read-only memory (ROM), electrically erasable programmable (ROM) (EEPROM), programmable ROM (PROM), a magnetic memory, a magnetic disk, or an optical disk, but is not limited thereto.

The processor 110 according to an embodiment of the disclosure may execute the one or more instructions stored in the memory 150 to obtain the first media data through the tuner unit 120. The processor 110 may also execute the one or more instructions stored in the memory 150 to obtain the first media data through at least one of the input/output unit 130 or the communicator 140.

The processor 110 according to an embodiment of the disclosure may execute the one or more instructions stored in the memory 150 to transmit the first media data to the display device 200 through the first transmission path.

The processor 110 according to an embodiment of the disclosure may execute the one or more instructions stored in the memory 150 to convert, based on the first transmission path being lost, the first media data into second media data.

The processor 110 according to an embodiment of the disclosure may execute the one or more instructions stored in the memory 150 to store the second media data in a local web server.

The processor 110 according to an embodiment of the disclosure may execute the one or more instructions stored in the memory 150 to transmit, according to a request from the display device 200, the second media data stored in the local web server to the display device 200 through the second transmission path that is different from the first transmission path. For example, the display device 200 connected to the same network (e.g., the second network 320) as the source device 100 may access the local web server of the source device 100 by using a URL including a local IP address of the source device 100.

Next, the display device 200 will be described.

The display device 200 according to an embodiment of the disclosure may include a processor 210, a communicator 220, a video processing unit 230, a display 240, and the memory 250. However, not all of the illustrated components are essential. The display device 200 may be implemented with more components than the illustrated components, or may be implemented with fewer components.

The communicator 220 may connect, under control by the processor 210, the display device 200 to a peripheral device, an external device, a server, or a mobile terminal. The communicator 220 may include various communication circuits included in at least one communication module. The communicator 220 may include a short-range communication module, a wireless Internet module, or a wired Ethernet, in accordance with the performance and structure of the display device 200.

The short-range communication module may be a module for short-range communication, and may include a WLAN module (or Wi-Fi module), a Bluetooth module, a Zigbee module, an IrDA module, and a WFD module, but is not limited thereto. The WLAN module may transmit/receive a Wi-Fi signal to/from a peripheral device according to the Wi-Fi communication standard. The Bluetooth module may receive a Bluetooth signal transmitted from a peripheral device, according to the Bluetooth communication standard. The WFD module may support P2P communication, which enables direct connection between two devices without an AP. Wi-Fi may use a frequency of a 2.4 GHz band, a 5 GHz band, or a 6 GHz band.

The wireless Internet module may be a module for wireless Internet access, and may be built into or external to a device. The wireless Internet module may include a WLAN module and a Wibro module. The wireless Internet module may be used to enable the display device 200 to communicate with a server device. The WLAN module may be used as a wireless Internet module when connecting to the Internet through an AP.

The first communication module of the display device 200 according to an embodiment of the disclosure may include a short-range communication module. The second communication module of the display device 200 according to an embodiment of the disclosure may include a wireless Internet module.

The video processing unit 230 may process video data to be displayed by the display 240, and may perform various image processing operations, such as decoding, rendering, scaling, noise cancelling, noise removal, frame rate conversion, and resolution conversion, on the video data. For example, the video processing unit 230 may include various image processing circuits. For example, the video processing unit 230 may include a media codec for processing image content. For example, the video processing unit 230 may include at least one of a first playback pipeline 720 of FIG. 7 or a second playback pipeline 920 of FIG. 9.

The display 240 may output, to a screen, content received from a broadcasting station, received from an external device, such as an external server or an external storage medium, or provided by various applications, for example, an OTT service provider or a content provider. The display 240 may display content that has been received from the source device 100 and image-processed.

The display device 200 according to an embodiment of the disclosure may process, through the video processing unit 230, the first media data received from the source device 100 through the first transmission path, and may play the processed first media data. The display device 200 may output the first media data to the display 240. The display device 200 according to an embodiment of the disclosure may process, through the video processing unit 230, the second media data received from the source device 100 through the second transmission path, and may play the processed second media data. The display device 200 may output the second media data to the display 240.

The processor 210 may be electrically connected to the components included in the display device 200, and may execute computation or data processing related to control and/or communication of the components included in the display device 200. In an embodiment of the disclosure, the processor 210 may load a request, a command, or data received from at least one of the other components into memory, may process the loaded request, command, or data, and may store processing result data in the memory. According to an embodiment of the disclosure, the processor 210 may include at least one of a general-purpose processor, such as a CPU, an AP (application processor), or a DSP, a graphics-only processor, such as a GPU or a VPU, or an artificial intelligence-only processor, such as an NPU.

The processor 210 may process input data or control the other components to process the input data, according to data, an operating rule, an algorithm, a method, or a model stored in the memory 250. The processor 210 may use the input data to perform an operation of a pre-defined operating rule, algorithm, method, or model stored in the memory 250.

The memory 250 may be electrically connected to the processor 210, and may store one or more modules, algorithms, operating rules, models, programs, instructions, or pieces of data related to operations of the components included in the display device 200. For example, the memory 250 may store one or more modules, algorithms, operating rules, models, programs, instructions, or pieces of data for processing and controlling by the processor 210. The memory 250 may include at least one type of storage medium from among a flash memory type, a hard disk type, a multimedia card micro type, a card type memory (e.g., an SD or XD memory), RAM, SRAM, ROM, EEPROM, PROM, a magnetic memory, a magnetic disk, or an optical disk, but is not limited thereto.

The processor 210 according to an embodiment of the disclosure may execute the one or more instructions stored in the memory 250 to receive the first media data from the source device 100 through the first transmission path.

The processor 210 according to an embodiment of the disclosure may execute the one or more instructions stored in the memory 250 to obtain, based on the first transmission path being lost, second media metadata for accessing the second media data.

The processor 210 according to an embodiment of the disclosure may execute the one or more instructions stored in the memory 250 to request, based on the second media metadata, the second media data from the source device 100.

The processor 210 according to an embodiment of the disclosure may execute the one or more instructions stored in the memory 250 to receive the second media data from the source device 100 through the second transmission path that is different from the first transmission path.

FIG. 4 is a flowchart for describing an operating method of a source device, according to an embodiment of the disclosure. An operating method of the source device 100 according to an embodiment of the disclosure may be performed by the processor 110 (see FIG. 3) of the source device 100.

Referring to FIG. 4, in operation 410, the source device 100 may obtain first media data.

The source device 100 according to an embodiment of the disclosure may obtain the first media data through the tuner unit 120. For example, the tuner unit 120 of the source device 100 may receive an RF signal from a broadcast network, may process the RF signal, and may output first media data, which is digital data. For example, the tuner unit 120 may select a signal of a specific channel from among RF signals received from the broadcast network, may demodulate the signal, and may obtain first media data corresponding to digital data. For example, the first media data may be data packetized according to a first communication protocol that is a standard available in the broadcast network. In this case, the first media data may be referred to as "RF data," but is not limited thereto.

When the source device 100 according to an embodiment of the disclosure receives an ATSC 3.0 broadcast signal, the first media data may be an ALP packet packetized according to ALP, which is a link-layer protocol used in an ATSC 3.0 broadcasting system. For example, the first media data may include a packet standardized according to an MMT/UDP/IP protocol, or a packet standardized according to a ROUTE/UDP/IP protocol. For example, the first media data may include OTA streaming data that is generated in an MPU format and MMT-packetized, or is generated in a DASH segment format and ROUTE-packetized.

In an embodiment of the disclosure, the first media data is illustrated as being received through the tuner unit 120, but is not limited thereto. For example, the first media data may be data received by the source device 100 from an external device through the input/output unit 130. In this case, the first media data may be data standardized according to a communication protocol (e.g., an HDMI standard protocol) that may be received through the input/output unit 130 (e.g., an HDMI port). Also, for example, the first media data may be data received from an external device through the communicator 140.

The first media data according to an embodiment of the disclosure may include content such as video, audio, and/or additional information. The first media data may be separated into video, audio, and/or additional information by the display device 200. Based on the separated data, the display device 200 may display content on a screen.

In operation 420, the source device 100 may transmit the first media data to the display device 200 through a first transmission path.

The source device 100 and the display device 200 according to an embodiment of the disclosure may be connected to each other through the first transmission path. The first transmission path may be a path through which the first media data is transmitted based on a first communication module that enables direct communication between the source device 100 and the display device 200. The source device 100 may directly transmit the first media data to the display device 200 based on the first transmission path, and thus may quickly and stably transmit large-capacity media data.

The first communication module according to an embodiment of the disclosure may include a short-range communication module. For example, the first communication module may include a Wi-Fi 7 module. The first communication module may enable direct communication between devices equipped with a Wi-Fi 7 module (hereinafter, referred to as "Wi-Fi devices") without going through an AP that supports connection between Wi-Fi devices. However, an embodiment of the disclosure is not limited thereto, and the first communication module may include a WLAN module (or Wi-Fi module), a Bluetooth module, a Zigbee module, an IrDA module, and a WFD module.

The source device 100 according to an embodiment of the disclosure may transmit the first media data to the display device 200 through the first transmission path without separate processing of the first media data. For example, the source device 100 may transmit the first media data to the display device 200 without processing such as demuxing or parsing to extract data of a layer higher than a physical layer (e.g., an Internet layer or a transport layer).

In an embodiment of the disclosure, the first transmission path may be a wireless communication path. However, an embodiment of the disclosure is not limited thereto, and the first transmission path may be a wired communication path. In this case, the first communication module may include a wired Ethernet.

In operation 430, the source device 100 may identify whether the first transmission path with the display device 200 has been lost.

The source device 100 according to an embodiment of the disclosure may monitor the first transmission path, and may identify whether the first transmission path has been maintained, lost, or recovered. The source device 100 may identify, while transmitting the first media data through the first transmission path, whether the first transmission path has been lost.

The source device 100 according to an embodiment of the disclosure may include a first connection management module (e.g., 730 of FIG. 7 or 930 of FIG. 9) that monitors a state of the first transmission path through the first communication module of the source device 100. When a signal received or transmitted by the first communication module is not received or transmitted within a predetermined time, the first connection management module may identify that the first transmission path has been lost. Alternatively, when the source device 100 transmits a connection state confirmation signal to the display device 200 but there is no response from the display device 200, the first connection management module may identify that the first transmission path has been lost. A scheme through which the first connection management module monitors the state of the first transmission path is not limited to the examples described above.

For example, while the first transmission path is maintained, a first pipeline (e.g., 710 of FIG. 7) for transmitting the first media data through the first transmission path may be activated. When the first transmission path is lost, the source device 100 may disable the first pipeline (e.g., 710 of FIG. 7). When the first transmission path is lost, the source device 100 may activate a second pipeline (e.g., 910 of FIG. 9) for transmitting second media data through a second transmission path.

Here, the first transmission path being maintained may indicate that the network environment supporting the first transmission path is stable. The first transmission path being lost may indicate that the first transmission path is disconnected, or that the network environment supporting the first transmission path is unstable. The first transmission path being recovered may indicate that the lost first transmission path has been reconnected.

The source device 100 according to an embodiment of the disclosure may monitor the first transmission path, and when the first transmission path is disconnected or unstable, may use an indirect communication scheme between devices through a broadband network, instead of a direct communication scheme between devices.

In operation 440, the source device 100 may convert, based on the first transmission path being lost, the first media data into second media data. In operation 450, the source device 100 may store the second media data in a local web server.

When the first transmission path is lost, the source device 100 according to an embodiment of the disclosure may generate second media data to be indirectly transmitted to the display device 200 through a broadband network connected to the second transmission path. The source device 100 may establish a local web server within the source device 100, and may store the second media data in the local web server.

The source device 100 according to an embodiment of the disclosure may generate, based on data packetized according to the first communication protocol (first media data), data packetized according to a second communication protocol (second media data). For example, the source device 100 may extract one or more media files contained in the first media data. The source device 100 may standardize the one or more media files according to the second communication protocol that is different from the first communication protocol.

For example, the second communication protocol may be a standard available in the broadband network. For example, the second media data may include a packet standardized according to an HTTP/TCP/IP protocol.

For example, the source device 100 may convert OTA streaming data that is generated in an MPU format and MMT-packetized, or is generated in a DASH segment format and ROUTE-packetized, to generate OTT streaming data that has a DASH segment format and may be transmitted as an HTTP message. The display device 200 may provide time information to each segment through an index or a time stamp. Accordingly, segments may not be lost or out of order. This aspect will be described in more detail in the description of a second pipeline 910 of FIG. 9.

The source device 100 according to an embodiment of the disclosure may establish a web server at a local host address thereof (e.g., 127.0.0.1), and may store the second media data at the local host address. For example, the source device 100 may store one or more segments corresponding to the second media data in the local web server together with generation time information of each segment. The time information of each segment may be used to match with availability start time information when the display device 200 requests segments later.

In an embodiment of the disclosure, the source device 100 may periodically generate segments according to a segment length (e.g., 2 seconds) starting from a time point when the first transmission path is lost (e.g., 12:00:00), and may store the generated segments in the local web server. The order or number of segments stored in the local web server may be distinguished according to a storage time point.

Meanwhile, in an embodiment of the disclosure, the source device 100 may transmit, to the display device 200 through the first transmission path, first media data received through an HDMI port, and even when the first transmission path is lost, the source device 100 may operate according to operations 440 and 450. For example, the source device 100 may receive HDMI-standardized first media data through the HDMI port, may convert the HDMI-standardized first media data to generate second media data standardized based on the second communication protocol, and may store the second media data in the local web server. For example, the source device 100 may divide the HDMI-standardized first media data at certain time intervals to generate segments, may add time information to each segment by using a time stamp, and may store the generated segments in the local web server. Accordingly, even while the source device 100 transmits the first media data received through the HDMI port to the display device 200, when direct communication between the source device 100 and the display device 200 is unstable, data transmission may be maintained through indirect communication between the source device 100 and the display device 200, thereby ensuring stable image viewing by the user.

In operation 460, the source device 100 may transmit the second media data to the display device 200 through a second transmission path.

The source device 100 and the display device 200 according to an embodiment of the disclosure may be connected to each other through the second transmission path. The second transmission path may be a path through which the second media data is transmitted based on a second communication module that enables communication between the source device 100 and the display device 200 through an AP.

The second communication module according to an embodiment of the disclosure may include a wireless Internet module. For example, the second communication module may include a WLAN module (Wi-Fi module). The second communication module may be a different module from the first communication module. In an embodiment of the disclosure, the second transmission path may be a wireless communication path. However, an embodiment of the disclosure is not limited thereto, and the second transmission path may be a wired communication path.

In an embodiment of the disclosure, the source device 100 may itself operate as a broadband IP server by establishing a local web server. For example, when the source device 100 receives an HTTP request from a web client (e.g., the display device 200) connected to the same network as the source device 100, the source device 100 may transmit the second media data in a streaming form to the web client through a broadband network.

In an embodiment of the disclosure, the source device 100 may receive a segment request from the display device 200 by using a URL including segment availability start time information and location information of the local web server. In response to the segment request (e.g., based on the segment request), the source device 100 may transmit a segment corresponding to the segment availability start time information, from among the one or more segments, to the display device 200 through the second transmission path. The source device 100 may identify a segment generated at the availability start time requested by the display device 200, and may transmit the identified segment to the display device 200.

In an embodiment of the disclosure, the segment availability start time information may correspond to a time point when the first transmission path is lost. The segment corresponding to the segment availability start time information may correspond to a segment generated by the source device 100 at the time point when the first transmission path is lost. The source device 100 may sequentially transmit, to the display device 200, segments starting from the segment generated at the time point when the first transmission path is lost. This aspect will be described with reference to FIG. 11.

The source device 100 according to an embodiment of the disclosure may delete a segment stored in the local web server when a certain condition is satisfied. For example, the source device 100 may delete from the local web server a segment identified as having been transmitted to a client. For example, the source device 100 may delete from the local web server a segment for which a certain time has elapsed since being stored. However, an embodiment of the disclosure is not limited thereto.

In an embodiment of the disclosure, even when direct communication between the source device 100 and the display device 200 is unstable, the source device 100 and the display device 200 may maintain data transmission by using indirect communication through an AP, thereby ensuring stable image viewing by the user.

FIG. 5 is a flowchart for describing an operating method of a display device, according to an embodiment of the disclosure. An operating method of the display device 200 according to an embodiment of the disclosure may be performed by the processor 210 (see FIG. 3) of the display device 200.

Referring to FIG. 5, in operation 510, the display device 200 may receive first media data from the source device 100 through a first transmission path.

The source device 100 and the display device 200 according to an embodiment of the disclosure may be connected to each other through the first transmission path. The first transmission path may be a path through which the first media data is received based on a first communication module that enables direct communication between the source device 100 and the display device 200.

The display device 200 according to an embodiment of the disclosure may directly receive the first media data from the source device 100 based on the first transmission path, and thus may quickly and stably receive large-capacity media data.

The first communication module according to an embodiment of the disclosure may include a short-range communication module. For example, the first communication module may include a Wi-Fi 7 module. The first communication module may enable direct communication between devices equipped with a Wi-Fi 7 module (hereinafter, referred to as "Wi-Fi devices") without going through an AP that supports connection between Wi-Fi devices. However, an embodiment of the disclosure is not limited thereto, and the first communication module may include a WLAN module (or Wi-Fi module), a Bluetooth module, a Zigbee module, an IrDA module, and a WFD module.

The first media data according to an embodiment of the disclosure may be data standardized according to a first communication protocol corresponding to a reception scheme of content received by the source device 100 from an external device. For example, when the content received by the source device 100 is broadcast content received through a broadcast, the first media data may be data packetized according to a communication protocol available in the broadcast network. For example, the first media data may include a packet standardized according to an MMT/UDP/IP protocol, or a packet standardized according to a ROUTE/UDP/IP protocol. For example, the first media data may include OTA streaming data that is generated in an MPU format and MMT-packetized, or is generated in a DASH segment format and ROUTE-packetized.

However, an embodiment of the disclosure is not limited thereto, and in this case, when the content received by the source device 100 is content received from an external device through an HDMI port, the first media data may be data standardized according to the HDMI standard.

In an embodiment of the disclosure, the first transmission path may be a wireless communication path. However, an embodiment of the disclosure is not limited thereto, and the first transmission path may be a wired communication path. In this case, the first communication module may include a wired Ethernet.

The first media data according to an embodiment of the disclosure may include content such as video, audio, and/or additional information. The first media data may be separated into video, audio, and/or additional information by the display device 200. Based on the separated data, the display device 200 may display content on a screen.

In operation 520, the display device 200 may play the first media data.

The display device 200 according to an embodiment of the disclosure may perform processing such as demuxing or parsing to extract data from a layer higher than a physical layer (e.g., an Internet layer or a transport layer). The display device 200 may perform processing such as decoding and rendering on the first media data to display content on the screen.

In operation 530, the display device 200 may identify whether the first transmission path with the source device 100 has been lost.

The display device 200 according to an embodiment of the disclosure may monitor the first transmission path, and may identify whether the first transmission path has been maintained, lost, or recovered. The display device 200 may identify, while receiving the first media data through the first transmission path, whether the first transmission path has been lost.

The display device 200 according to an embodiment of the disclosure may include a second connection management module (e.g., 740 of FIG. 7 or 940 of FIG. 9) that monitors a state of the first transmission path through the first communication module of the display device 200. When a signal received or transmitted by the first communication module is not received or transmitted within a predetermined time, the second connection management module may identify that the first transmission path has been lost. Alternatively, when the display device 200 transmits a connection state confirmation signal to the source device 100 but there is no response from the source device 100, the second connection management module may identify that the first transmission path has been lost. A scheme through which the second connection management module monitors the state of the first transmission path is not limited to the examples described above.

For example, while the first transmission path is maintained, a first playback pipeline (e.g., 720 of FIG. 7) for transmitting the first media data through the first transmission path may be activated. When the first transmission path is lost, the display device 200 may disable the first playback pipeline. When the first transmission path is lost, the display device 200 may activate a second playback pipeline (e.g., 920 of FIG. 9) for transmitting second media data through a second transmission path.

Here, the first transmission path being maintained may indicate that the first transmission path is stably connected. The first transmission path being lost may indicate that the first transmission path is disconnected or unstable. The first transmission path being recovered may indicate that the lost first transmission path has been reconnected.

The display device 200 according to an embodiment of the disclosure may monitor the first transmission path, and when the first transmission path is disconnected or unstable, may use an indirect communication scheme between devices through a broadband network, instead of a direct communication scheme between devices.

In operation 540, the display device 200 may generate second media metadata, based on the first transmission path being lost.

The second media metadata according to an embodiment of the disclosure may include information for the display device 200 to access a local web server and request one or more segments corresponding to second media data. The second media metadata may include bibliographic information about the segments corresponding to the second media data. The second media metadata may correspond to an MPD file.

The second media metadata according to an embodiment of the disclosure may include location information of a local web server of the source device 100 and segment availability start time information. Here, the location information of the local web server may indicate a local IP address of the local web server (e.g., 127.0.0.1). The display device 200 may have pre-stored therein a local IP address of the source device 100 connected to the same network as the display device 200. Here, the availability start time information may be used as a segment file name for requesting a specific file from among multiple files stored in the local web server. The availability start time information may include information used to determine a first segment to request from the local web server. For example, the display device 200 may update the time point when the first transmission path is lost as the availability start time. In this case, the display device 200 may request segments starting from a segment stored in the local web server at the time point when the first transmission path is lost.

However, an embodiment of the disclosure is not limited thereto, and the second media metadata may further include a start time, an end time, a cycle, a file name, a length, and a content type of each segment.

The display device 200 according to an embodiment of the disclosure may generate second media metadata for the second media data by using channel list information received together with the first media data through the first transmission path. The channel list information may be received together with a broadcast signal received by the source device 100 through a tuner unit, and may include a service list table (SLT). The channel list information received together with the first media data may be referred to as "first media metadata." The display device 200 may generate second media metadata for requesting the second media data by adding location information of the local web server and availability start time information to the channel list information received together with the first media data.

In operation 550, the display device 200 may request, based on the second media metadata, the second media data from the source device 100. In operation 560, the display device 200 may receive the second media data from the source device 100 through a second transmission path.

The display device 200 according to an embodiment of the disclosure may request a segment by using a URL (e.g., http/127.0.0.1/start=a) including location information of the local web server of the source device 100 (e.g., 127.0.0.1) and a segment file name (e.g., start=a). The segment file name may be a segment availability start time, but is not limited thereto.

The display device 200 according to an embodiment of the disclosure may access the local web server, based on the location information of the local web server.

The display device 200 according to an embodiment of the disclosure may determine, based on the availability start time information, which time point segment to request, from among the one or more segments stored in the local web server. For example, the display device 200 may request a segment stored at a time point corresponding to the segment availability start time information, and may receive the segment. That is, the display device 200 may request segments from the source device 100 starting from a segment stored at the same time as the availability start time, and may receive the segment.

For example, the availability start time information may correspond to the time point when the first transmission path is lost. The display device 200 may request a segment stored in the local web server at a time corresponding to the time point when the first transmission path is lost. For example, when the first transmission path is lost at 12:00:00, the display device 200 may set 12:00:00 as the segment availability start time, and may request segments starting from a segment stored at 12:00:00 in the local web server.

In this case, the source device 100 according to an embodiment of the disclosure may transmit, to the display device 200, segments starting from a segment stored at the same time as the availability start time, based on the availability start time information requested by the display device 200. The order of each segment stored in the local web server may be distinguished according to a storage time of each segment. For example, when the availability start time is 12:00:00, the source device 100 may transmit to the display device 200, according to a request from the display device 200, a segment stored at 12:00:00. Here, the time point when the segment is stored may refer to a time point when the first media data is converted into the second media data and stored in a certain path of the local web server.

The availability start time information recorded in the display device 200 may be recorded according to a standard time (e.g., coordinated universal time (UTC)). Also, the generation time information recorded in the source device 100 may be recorded according to a standard time (e.g., UTC). The web client and the local web server refer to the same standard time, and thus may be synchronized with each other.

The source device 100 may generate segments starting from the time point when the first transmission path is lost, and may transmit the generated segments through the second transmission path according to a request from the display device 200, thereby ensuring real-time image viewing by the user.

The operation in which the source device 100 and the display device 200 request and transmit segments will be described in more detail with reference to FIG. 11.

In operation 570, the display device 200 may play the second media data.

The display device 200 according to an embodiment of the disclosure may perform processing such as demuxing or parsing on the second media data. For example, the display device 200 may perform processing on the second media data packetized according to specifications of the second communication protocol. The display device 200 may perform processing such as decoding and rendering on the second media data to display content on the screen.

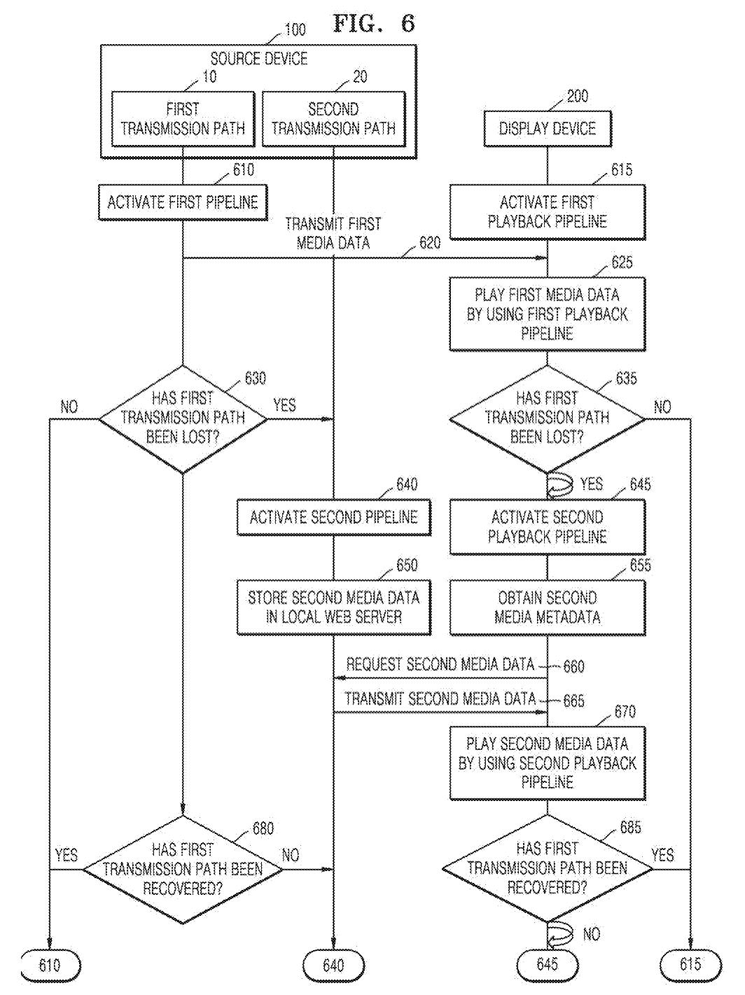

FIG. 6 is a flowchart for describing operating methods of a source device and a display device that are connected to each other through a first transmission path and a second transmission path, according to an embodiment of the disclosure. In the description of FIG. 6, descriptions overlapping those provided with reference to FIGS. 4 and 5 will be briefly presented. In the description of FIG. 6, descriptions overlapping those of the first pipeline 710, the second pipeline 910, the first playback pipeline 720, and the second playback pipeline 920 illustrated in FIGS. 7 and 9, which will be described below, will be briefly presented.

Referring to FIG. 6, in operation 610, the source device 100, when connected to the display device 200 through the first transmission path 10, may activate the first pipeline 710. In operation 615, the display device 200, when connected to the source device 100 through the first transmission path 10, may activate the first playback pipeline 720. The first pipeline 710 of the source device 100 according to an embodiment of the disclosure may include a suitable logic, circuit, interface, and/or code for transmitting first media data received from an external device through the first transmission path 10. The first playback pipeline 720 of the display device 200 according to an embodiment of the disclosure may include a suitable logic, circuit, interface, and/or code for playing the first media data received through the first transmission path 10.

In operation 620, the source device 100 may transmit the first media data to the display device 200 through the first transmission path 10. The display device 200 may receive the first media data from the source device 100 through the first transmission path 10. In operation 625, the display device 200 may play the first media data by using the first playback pipeline 720. Operation 620 may correspond to operation 420 of FIG. 4 and operation 510 of FIG. 5. Operation 625 may correspond to operation 520 of FIG. 5.

In operations 630 and 635, each of the source device 100 and the display device 200 may identify whether the first transmission path 10 has been lost. For example, the source device 100 may monitor a state of the first transmission path 10 through a first connection management module (e.g., 730 of FIG. 7 or 930 of FIG. 9) that monitors the state of the first transmission path 10 through the first communication module of the source device 100. Also, for example, the display device 200 may monitor the state of the first transmission path 10 through a second connection management module (e.g., 740 of FIG. 7 or 940 of FIG. 9) that monitors the state of the first transmission path 10 through the first communication module of the display device 200. Operation 630 may correspond to operation 430 of FIG. 4. Operation 635 may correspond to operation 530 of FIG. 5.

In operation 640, when the first transmission path 10 is lost, the source device 100 may activate the second pipeline 910 to be connected to the display device 200 through the second transmission path 20. However, when the first transmission path 10 is not lost, the source device 100 may maintain the activated state of the first pipeline 710, according to operation 610.

In operation 645, when the first transmission path 10 is lost, the display device 200 may activate the second playback pipeline 920 to be connected to the source device 100 through the second transmission path 20. However, when the first transmission path 10 is not lost, the display device 200 may maintain the activated state of the first playback pipeline 720, according to operation 615.

The second pipeline 910 of the source device 100 according to an embodiment of the disclosure may include a suitable logic, circuit, interface, and/or code for generating, from the first media data, second media data that may be transmitted through a broadband network, and transmitting the second media data through the second transmission path 20. The second playback pipeline 920 of the display device 200 according to an embodiment of the disclosure may include a suitable logic, circuit, interface, and/or code for playing the second media data received through the second transmission path 20.

In operation 650, the source device 100 may generate second media data from the first media data through the second pipeline 910. The source device 100 may store the second media data in a local web server. Operation 650 may correspond to operations 440 and 450 of FIG. 4.

In operation 655, the display device 200 may obtain second media metadata. Operation 655 may correspond to operation 540 of FIG. 5.

In operation 660, the display device 200 may request, based on the second media metadata, the second media data from the source device 100 through the second transmission path 20. The source device 100 may receive a second media data request from the display device 200 through the second transmission path 20. Operation 660 may correspond to operation 550 of FIG. 5.

In operation 665, the source device 100 may transmit, in response to the request, the second media data to the display device 200 through the second transmission path 20. The display device 200 may receive the second media data from the source device 100 through the second transmission path 20. Operation 665 may correspond to operation 460 of FIG. 4 and operation 560 of FIG. 5.

In operation 670, the display device 200 may play the second media data by using the second playback pipeline 920. Operation 670 may correspond to operation 570 of FIG. 5.

In operation 680, the source device 100 may identify whether the first transmission path 10 has been recovered. When the first transmission path 10 is recovered, the source device 100 may activate the first pipeline 710, according to operation 610, and may deactivate the second pipeline 910. The source device 100 may transmit, according to the first pipeline 710, the first media data to the display device 200 through the first transmission path 10. However, when the first transmission path 10 is not recovered, the source device 100 may maintain the activated state of the second pipeline 910, according to operation 640.

In operation 685, the display device 200 may identify whether the first transmission path 10 has been recovered. When the first transmission path 10 is recovered, the display device 200 may activate the first playback pipeline 720, according to operation 615, and may deactivate the second playback pipeline 920. The display device 200 may receive, according to the first playback pipeline 720, the first media data from the source device 100 through the first transmission path 10. However, when the first transmission path 10 is not recovered, the display device 200 may maintain the activated state of the second playback pipeline 920, according to operation 645.

In the system including the source device 100 and the display device 200 according to an embodiment of the disclosure, resources (e.g., ALP Demux and ATSC3 Demux) used by the display device 200 while the first transmission path 10 is maintained may be switched to be used by the source device 100 while the first transmission path is lost. For example, the first pipeline 710 (see FIG. 7) and the first playback pipeline 720 (see FIG. 7) may be logics implemented such that the first media data received by the source device 100 is transmitted to the display device 200 through the first transmission path 10, and the display device 200 processes the first media data. In contrast, the second pipeline 910 and the second playback pipeline 920 may be logics implemented such that, when the first transmission path 10 is lost, the source device 100 generates second media data from the first media data and transmits the second media data to the display device 200 through the second transmission path 20, and the display device 200 processes the second media data.

Meanwhile, a transmission rate per second of the first media data may be greater than a transmission rate per second of the second media data.

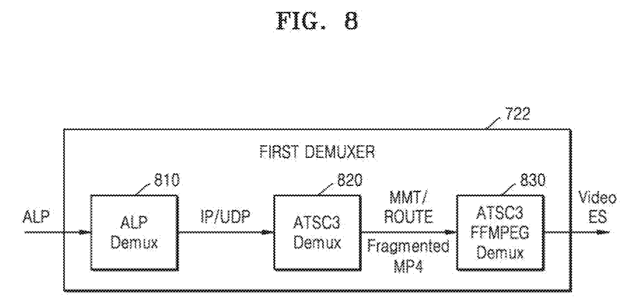

FIG. 7 is a diagram for describing operations of a source device and a display device that are connected to each other through a first transmission path, according to an embodiment of the disclosure. FIG. 8 is a diagram for describing an operation of a first demuxer of FIG. 7. FIGS. 7 and 8 illustrate a case where the source device 100 receives an ATSC 3.0 broadcast signal, but an input signal received by the source device 100 is not limited thereto. For example, when the input signal received by the source device 100 is an HDMI signal, a first demuxer 722 may be replaced with a component for parsing and extracting data standardized according to the HDMI standard.

Referring to FIG. 7, the source device 100 and the display device 200 according to an embodiment of the disclosure may be connected to each other through a first transmission path. The first transmission path may be a path through which first media data is transmitted based on a first communication module that enables direct communication between the source device 100 and the display device 200. Here, the first transmission path may be a wireless communication path, but is not limited thereto.

The first transmission path according to an embodiment of the disclosure may be connected to the first pipeline 710 of the source device 100 and the first playback pipeline 720 of the display device 200.

The first pipeline 710 of the source device 100 may include a tuner unit 711 and a virtual output unit 712. The first pipeline 710 may be connected to a first connection management module 730. The tuner unit 711 may correspond to the tuner unit 120 of FIG. 3.

The tuner unit 711 may receive an RF signal from a broadcast network, may process the RF signal, and may output first media data, which is digital data. In this case, the first media data may be referred to as "RF data," but is not limited thereto. The first media data may be transmitted to the first playback pipeline 720 through the first pipeline 710.

When the tuner unit 711 according to an embodiment of the disclosure receives an ATSC 3.0 broadcast signal, a demodulator belonging to the tuner unit 711 may convert data of a physical layer to a link layer, which is the next layer (e.g., ALP). The first media data may be an ALP packet packetized according to ALP, which is a link-layer protocol used in an ATSC 3.0 broadcasting system. The ALP packet may contain data of a higher layer (e.g. MMTP or IP). For example, a payload of the ALP packet may contain IP packets. A header of the ALP packet may include a packet type field, and the packet type field may be used by a receiver to identify the type of a data packet. For example, the first media data may include a packet standardized according to an MMT/UDP/IP protocol, or a packet standardized according to a ROUTE/UDP/IP protocol. For example, the first media data may include OTA streaming data that is generated in an MPU format and MMT-packetized, or is generated in a DASH segment format and ROUTE-packetized.

In an embodiment of the disclosure, the first media data is illustrated as being received through the tuner unit 711, but is not limited thereto. For example, the first media data may be data received from an external device through the input/output unit 130 of FIG. 3. For example, the first media data may be data standardized according to a communication protocol that may be received through an HDMI port.

The first pipeline 710 according to an embodiment of the disclosure may transmit the extracted first media data to the first playback pipeline 720 through the first transmission path. With 1,500 bytes per packet and 1,400 packets transmitted per second, 2 Mbtyes of data may be transmitted per second.

The first playback pipeline 720 may include a virtual receiver 721, the first demuxer 722, a decoder 723, and an output unit 724. The first playback pipeline 720 may be connected to a second connection management module 740. The decoder 723 and the output unit 724 may be included in the video processing unit 230 of FIG. 3.

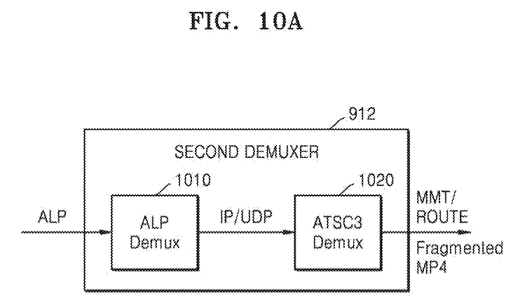

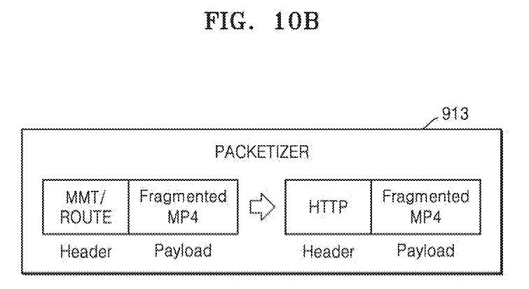

The first demuxer 722 may parse the ALP packet to identify that data included in the ALP packet is network streaming data of an IP packet type, and may separate the data into respective streams (video, audio, and additional information). Specifically, referring to FIG. 8, the first demuxer 722 may include an ALP demuxer 810 that receives the ALP packet and extracts an IP/UDP packet from the ALP packet. The ALP demuxer 810 may parse the received ALP packet, may identify the packet type, and may extract an IP/UDP packet from the ALP packet. The extracted IP/UDP packet may be transmitted to an ATSC3 demuxer 820. The first demuxer 722 may further include the ATSC3 demuxer 820 that receives the IP/UDP packet and assembles the IP/UDP packet into an MMT/ROUTE packet. A payload of the MMT/ROUTE packet may contain a media file in a fragmented MP4 format (see FIG. 10B). The MMT/ROUTE packet may be transmitted to an ATSC3 FFMPEG demuxer 830. The first demuxer 722 may further include the ATSC3 FFMPEG demuxer 830 that parses the MMT/ROUTE packet and extracts an elementary stream (ES) from the fragmented MP4. The ATSC3 FFMPEG demuxer 830 may be a demuxer that separates compressed video and audio streams from the fragmented MP4 and converts the separated video and audio streams into data recognizable by a decoder. A video ES may be referred to as "encoded video data."

The video stream and the audio stream may be respectively transmitted to a video decoder and an audio decoder within the decoder 723. Each of the video decoder and the audio decoder may decode compressed media data, and may transmit the decoded media data to the output unit 724. The output unit 724 may include a rendering unit. The output unit 724 may render a compressed video stream (e.g., HEVC) on the screen on a per-frame basis after the video stream has been decoded.

The first transmission path according to an embodiment of the disclosure may be a path for a virtual connection that connects two devices to each other through software without a physical connection. The term "virtual connection" may refer to connecting two devices to each other through wireless communication over a network. In this case, the virtual output unit 712 and the virtual receiver 721, which are software modules for configuring respective pipelines, may be included between the tuner unit 711 of the first pipeline 710 and the first demuxer 722 of the first playback pipeline 720. The virtual output unit 712 may operate as an output terminal in an input-output structure of the first pipeline 710. The virtual receiver 721 may operate as an input terminal in an input-output structure of the first playback pipeline 720. However, the virtual output unit 712 and the virtual receiver 721 may be omitted.

The first connection management module 730 according to an embodiment of the disclosure may monitor the first communication module of the source device 100. When a signal received or transmitted by the first communication module is not received or transmitted within a predetermined time, the first connection management module 730 may identify that the first transmission path has been lost. A scheme through which the first connection management module 730 monitors the state of the first transmission path is not limited to the example described above. The first connection management module 730 may monitor the first communication module and, when determining that the first transmission path has been lost, may transmit, to the source device 100, a signal indicating the loss of the first transmission path. When receiving the signal indicating the loss of the first transmission path, the source device 100 may deactivate the first pipeline 710. When receiving the signal indicating the loss of the first transmission path, the source device 100 may activate the second pipeline 910 of FIG. 9, which will be described below. For example, the source device 100 may generate a disable signal for the first pipeline 710, and may generate an enable signal for the second pipeline 910.

The second connection management module 740 according to an embodiment of the disclosure may monitor the first communication module of the display device 200. When a signal received or transmitted by the first communication module is not received or transmitted within a predetermined time, the second connection management module 740 may identify that the first transmission path has been lost. A scheme through which the second connection management module 740 monitors the state of the first transmission path is not limited to the example described above. The second connection management module 740 may monitor the first communication module and, when determining that the first transmission path has been lost, may transmit, to the display device 200, a signal indicating the loss of the first transmission path. When receiving the signal indicating the loss of the first transmission path, the display device 200 may deactivate the first playback pipeline 720. When receiving the signal indicating the loss of the first transmission path, the display device 200 may activate the second playback pipeline 920 of FIG. 9, which will be described below. For example, the display device 200 may generate a disable signal for the first playback pipeline 720, and may generate an enable signal for the second playback pipeline 920.

In an embodiment of the disclosure, the source device 100 and the display device 200 are illustrated as including connection management modules that monitor respective first communication modules, but are not limited thereto. For example, a connection management module may be provided in at least one of the source device 100 or the display device 200.

The source device 100 according to an embodiment of the disclosure may transmit the first media data obtained by the tuner unit 711 to the display device 200 through the first transmission path without separate processing. For example, the source device 100 may omit an operation of extracting data of a higher layer than a physical layer (e.g., an Internet layer or a transport layer). For example, the source device 100 may transmit the first media data to the display device 200 without processing such as demuxing or parsing. In this case, the display device 200 may perform higher layer processing, such as demuxing or parsing, on the first media data, and, after decoding and rendering of the first media data, may output content corresponding to the first media data.

FIG. 9 is a diagram for describing operations of a source device and a display device that are connected to each other through a second transmission path, according to an embodiment of the disclosure. FIG. 10A is a diagram for describing an operation of a second demuxer of FIG. 9. FIG. 10B is a diagram for describing an operation of a packetizer of FIG. 9. FIGS. 9, 10A, and 10B illustrate a case where the source device 100 receives an ATSC 3.0 broadcast signal, but an input signal received by the source device 100 is not limited thereto. For example, when the input signal received by the source device 100 is an HDMI signal, a second demuxer 912 may be replaced with a component for parsing and extracting data standardized according to the HDMI standard.

Referring to FIG. 9, the source device 100 and the display device 200 according to an embodiment of the disclosure may be connected to each other through a second transmission path. The second transmission path may be a path through which second media data is transmitted based on a second communication module that enables communication between the source device 100 and the display device 200 through the AP 50. The second transmission path may be a path used to transmit media data when a wireless communication connection supporting the first transmission path is lost. Here, the second transmission path may be a wireless communication path, but is not limited thereto.

The second transmission path according to an embodiment of the disclosure may be connected to the second pipeline 910 of the source device 100 and the second playback pipeline 920 of the display device 200.

The second pipeline 910 of the source device 100 may include a tuner unit 911, the second demuxer 912, a packetizer 913, and a local web server 914. The second pipeline 910 may be connected to a first connection management module 930. The tuner unit 911 may correspond to the tuner unit 120 of FIG. 3 and the tuner unit 711 of FIG. 7. The first connection management module 930 may correspond to the first connection management module 730 of FIG. 7.

The tuner unit 911 according to an embodiment of the disclosure may receive an RF signal from a broadcast network, may process the RF signal, and may output first media data, which is digital data. The first media data may be transmitted to the second demuxer 912.

When the tuner unit 911 according to an embodiment of the disclosure receives an ATSC 3.0 broadcast signal, the first media data may be an ALP packet. The ALP packet may contain data of a higher layer (e.g. an MMT or IP packet). For example, the first media data may include a packet standardized according to an MMT/UDP/IP protocol, or a packet standardized according to a ROUTE/UDP/IP protocol.

The second demuxer 912 may parse the first media data, and may extract data of a higher layer. For example, the second demuxer 912 may parse the ALP packet, and may extract an MMT/ROUTE packet. Referring to FIG. 10A, the second demuxer 912 may include an ALP demuxer 1010 that receives the ALP packet and extracts an IP/UDP packet from the ALP packet. The ALP demuxer 1010 may correspond to the ALP demuxer 810 of FIG. 8. The second demuxer 912 may further include an ATSC3 demuxer 1020 that receives the IP/UDP packet and assembles the IP/UDP packet into an MMT/ROUTE packet. The ATSC3 demuxer 1020 may correspond to the ATSC3 demuxer 820 of FIG. 8. The ATSC3 demuxer 1020 may transmit the MMT/ROUTE packet to the packetizer 913. The MMT/ROUTE packet may contain a media file.

The packetizer 913 may convert the format of a media file received through a broadcast network so that the media file may be transmitted through the Internet. For example, referring to FIG. 10B, the packetizer 913 may convert the MMT/ROUTE packet into a DASH segment format. The packetizer 913 may parse the MMT/ROUTE packet to remove a MMT/ROUTE header, and may extract a media file (e.g., in an MPU format or a DASH segment format) contained in a payload of the MMT/ROUTE packet. For example, the packetizer 913 may convert the extracted media file in the MPU format into a media file in the DASH segment format. The packetizer 913 may add an HTTP header to the media file in the DASH segment format. Here, the format of the media file is illustrated as a fragmented MP4 format, but is not limited thereto. DASH segments may be stored in the local web server 914.

The local web server 914 may store the DASH segments at a local host address of the source device 100 (e.g., 127.0.0.1). When a segment is requested from a web client through an HTTP/TCP/IP protocol, the local web server 914 may transmit the segment in response to the request. Each segment may have a unique index (or order), and may be used when the display device 200 requests media data for a specific time point. For example, the order of each segment may be distinguished by a generation time point (or storage time point) of each segment.

For example, when a segment request is received from the display device 200 connected to the source device 100 through the AP 50 and the second transmission path, the local web server 914 may transmit a segment to the second playback pipeline 920 of the display device 200. Each segment may be transmitted at a size of kBytes per second. This may be less than the amount of the first media data transmitted through the first communication module.

The second playback pipeline 920 according to an embodiment of the disclosure may include a receiver 921, a third demuxer 922, a decoder 923, and an output unit 924. The second playback pipeline 920 may be connected to a second connection management module 940 and a metadata obtaining module 950. The decoder 923 and the output unit 924 may be included in the video processing unit 230 of FIG. 3. The second connection management module 940 may correspond to the second connection management module 740 of FIG. 7.

The receiver 921 may receive an MPEG-DASH segment standardized according to an HTTP/TCP/IP protocol, which is a standard available in a broadband network. The receiver 921 may transmit the MPEG-DASH segment to the third demuxer 922.

The third demuxer 922 may parse the MPEG-DASH segment standardized according to the HTTP/TCP/IP protocol, and may separate the segment to extract video and audio streams that are recognizable by the decoder 923.

The video stream and the audio stream may be respectively transmitted to a video decoder and an audio decoder within the decoder 923. Each of the video decoder and the audio decoder may decode compressed media data, and may transmit the decoded media data to the output unit 924. The output unit 924 may include a rendering unit. The output unit 924 may render a compressed video stream (e.g., HEVC) on the screen on a per-frame basis after the video stream has been decoded.

The first connection management module 930 according to an embodiment of the disclosure may monitor the first communication module of the source device 100. The first connection management module 930 may monitor the first communication module of the source device 100, and may determine whether the lost first transmission path has been recovered. When a signal indicating the recovery of the first transmission path is obtained through the first connection management module 930, the source device 100 may deactivate the second pipeline 910, and may activate the first pipeline 710 of FIG. 7 described above.

The second connection management module 940 according to an embodiment of the disclosure may monitor the first communication module of the display device 200. Similar to the first connection management module 930 described above, when the first transmission path is recovered, the second connection management module 940 may notify the display device 200 of the recovery of the first transmission path. In this case, the display device 200 may deactivate the second playback pipeline 920, and may activate the first playback pipeline 720 of FIG. 7 described above.

The metadata obtaining module 950 according to an embodiment of the disclosure may obtain second media metadata. When the first transmission path is lost, the metadata obtaining module 950 may convert first media metadata received together with the first media data to generate second media metadata for requesting the second media data. The second playback pipeline 920 may identify, based on the generated second media metadata, which segment to start from and the order in which to request segments. This aspect will be described with reference to FIG. 11.

FIG. 11 is a diagram for describing a second media data playback process between a source device and a display device, according to an embodiment of the disclosure.

Referring to FIG. 11, the source device 100 may generate one or more segments containing streaming data, and may upload the generated segments to a local web server. A segment may correspond to an MPEG-DASH segment. A segment may represent an image fragment divided into certain time units (e.g., about 1 second to about 10 seconds in length). The source device 100 may store the MPEG-DASH segments in the local web server. The source device 100 may also store information such as file names and generation time information of the MPEG-DASH segments. For example, the source device 100 may store the segments at a local IP address, such as 127.0.0.1. The source device 100 may generate segments starting from a time point when the first transmission path is lost, and may upload the generated segments to the local web server.

The display device 200 may generate second media metadata including information for accessing the local web server. The second media metadata may correspond to an MPD file. The display device 200 may input the MPD file into a DASH player to access the source device 100, which is the local web server, and may access the one or more segments stored in the local web server. A player implemented in the display device 200 may load a segment by using the MPD file, and may play content. The MPD file may also be referred to as a "media description file," a "manifest file," or a "playlist."

The display device 200 may generate an MPD file for the second media data by using channel list information received together with the first media data through the first transmission path. The channel list information may be included in a broadcast signal received by the source device 100 through a tuner unit, and may include an SLT. The channel list information received together with the first media data may be referred to as "first media metadata."

The display device 200 may generate an MPD file for the second media data by adding information such as location information of the local web server and availability start time information to the channel list information received together with the first media data. The MPD file for the second media data may be as information for requesting the second media data, and may be referred to as "second media metadata." For example, the display device 200 may convert the first media metadata received together with the first media data to generate second media metadata for requesting the second media data.

The drawing illustrates a first MPD file, a second MPD file, and a third MPD file for requesting a first segment, a second segment, and a third segment.

An MPD file may include information such as an availability start time 1110 of a segment, a length 1120 of the segment, a local web server address 1130 where the segment is stored, period ID and period start time 1140, and a content type 1150. For example, the availability start time 1110 may indicate a standard start time at which streaming service is available and may be a reference point of a streaming session timeline. In one example, the availability start time 1110 may be 12:00:00. In an embodiment of the disclosure, the availability start time 1110 may indicate a time point when the first transmission path is lost. The length 1120 of the segment may be 2 seconds. The local web server address 1130 may indicate a base path through which segments can be downloaded. In one example, the local web server address 1130 may be 127.0.0.1, which is a BaseURL. With respect to the period ID and the period start time 1140, the period ID may indicate an identifier for identifying a period within a timeline of a streaming session, and the period start time may represent a point or position at which the period begins in the timeline. In one example, the period ID and the period start time 1140 may correspond to a period ID of P0 and a period starting from 0 seconds of playback. The content type 1150 may be represented as stream information, such as video, audio, and subtitles existing in an adaptation set. However, the disclosure is not limited thereto, and the MPD file may further include information of an entire segment timeline (e.g., a duration (d) of one segment, a total number of segments within the period (repeat, r), and a start time (timestamp, t) of a first segment within the period.

The display device 200 may identify, based on the MPD file, which segment to start from and the order in which to request segments. The display device 200 may request a segment corresponding to the availability start time by using the BaseURL defined in the MPD file. The request may be in the form of an HTTP GET request, for example, a URL in which availability start time information is added to the BaseURL, such as http://127.0.0.1/start=12:00:00. That is, the availability start time information may be used as a segment file name for requesting a specific file from among multiple files stored in the local web server. The source device 100 may, in response to the request, transmit the first segment stored at a time corresponding to the availability start time to the local web server. The response format may be HTTP POST. For example, the source device 100 may transmit segments starting from a segment stored at the time point when the first transmission path is lost.

For example, when the first transmission path is lost at 12:00:00, the display device 200 may set 12:00:00 as the segment availability start time, and may request segments starting from a segment stored at 12:00:00 in the local web server. The source device 100 may identify, according to the request from the display device 200, the segment stored at 12:00:00, and may transmit the segment to the display device 200.

The display device 200 may continue to request segments from the source device 100 and proceed with playback until all media defined in the adaptation set of the MPD file have been played. When the first transmission path is recovered, the display device 200 may stop requesting segments.

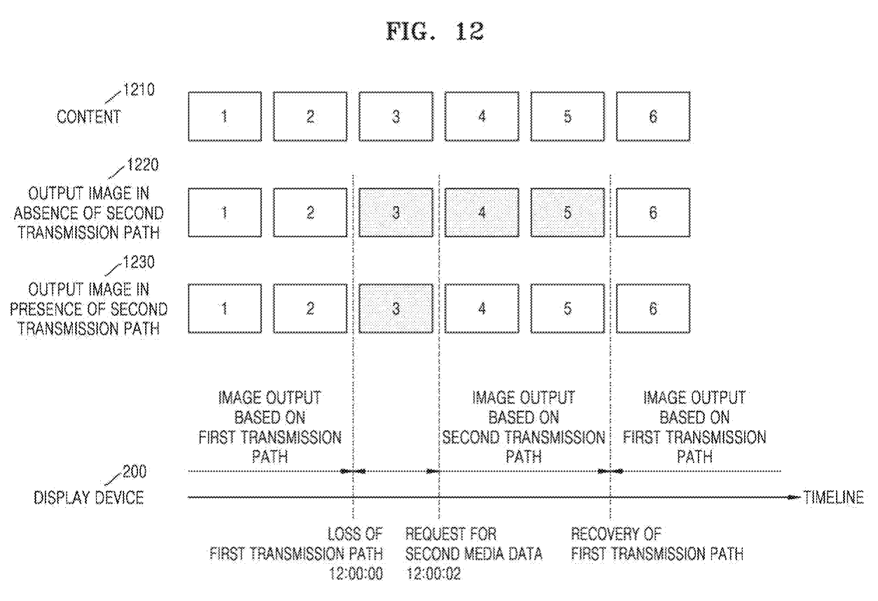

FIG. 12 is a diagram for describing a screen of content output to a display device in various scenarios, according to an embodiment of the disclosure.

Referring to 1210 of FIG. 12, media files played on the display device 200 when the source device 100 transmits real-time image content to the display device 200 in a stable network environment are illustrated. For example, the media files may be played sequentially in real time starting from media file 1 to media file 6.

Referring to 1220, in a scenario where the first transmission path is lost, media files played on the display device 200 when the second transmission path is absent are illustrated. In this case, the display device 200 may not play media files starting from a time point when the first transmission path is lost to a time point when the first transmission path is recovered (media file 3, media file 4, and media file 5). Accordingly, some of the real-time image content may not be available to the user.

Referring to 1230, in the scenario where the first transmission path is lost, media files played on the display device 200 when the second transmission path is present are illustrated. In this case, the display device 200 may play, based on the second transmission path, media files starting from the time point when the first transmission path is lost to the time point when the first transmission path is recovered (media file 4 and media file 5). Accordingly, the source device 100 and the display device 200 may ensure uninterrupted real-time playback of content.

Meanwhile, ideally, when the time point when the first transmission path is lost and the time point when the second transmission path is connected are the same, all of media file 3, media file 4, and media file 5 may be played on the display device 200. However, when the connection time point of the second transmission path is later than the loss time point of the first transmission path, media file 3, which is stored between the loss time point of the first transmission path and the connection time point of the second transmission path, may not be played. FIG. 12 illustrates a situation where media file 3 is not displayed, but an embodiment of the disclosure is not limited thereto.

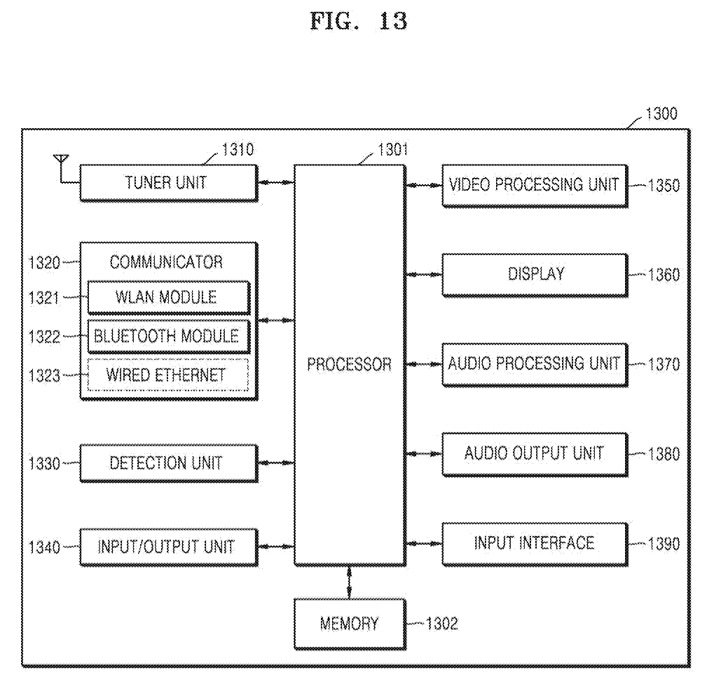

FIG. 13 is a detailed block diagram of a display device according to an embodiment of the disclosure.

Referring to FIG. 13, a display device 1300 may include a processor 1301, memory 1302, a tuner unit 1310, a communicator 1320, a detection unit 1330, an input/output unit 1340, a video processing unit 1350, a display 1360, an audio processing unit 1370, an audio output unit 1380, and an input interface 1390. The processor 1301, the memory 1302, the communicator 1320, the video processing unit 1350, and the display 1360 included in the display device 1300 may perform the same operations as the processor 210, the memory 250, the communicator 220, the video processing unit 230, and the display 240 included in the display device 200 of FIG. 3.

The tuner unit 1310 may tune and select only a frequency of a desired channel to be received by the display device 1300 from among a large number of radio wave components through amplification, mixing, or resonance of broadcast content received by wire or wirelessly. The content received through the tuner unit 1310 may be decoded and separated into audio, video, and/or additional information. The separated audio, video, and/or additional information may be stored in the memory 1302 under control by the processor 1301.

The communicator 1320 may connect, under control by the processor 1301, the display device 1300 to a peripheral device, an external device, a server, or a mobile terminal. The communicator 1320 may include at least one communication module capable of performing wireless communication. The communicator 1320 may include at least one of a WLAN module 1321, a Bluetooth module 1322, or a wired Ethernet 1323, in accordance with the performance and structure of the display device 1300.

The WLAN module 1321 may transmit/receive a Wi-Fi signal to/from a peripheral device according to the Wi-Fi communication standard. The Bluetooth module 1322 may receive a Bluetooth signal transmitted from a peripheral device, according to the Bluetooth communication standard.

The detection unit 1330 may detect a user's voice, a user's image, or a user's interaction, and may include a microphone, a camera unit, a light receiver, and a sensing unit.

The input/output unit 1340 may receive, under control by the processor 1301, video (e.g., a dynamic image signal or a still image signal), audio (e.g., a voice signal or a music signal), and additional information from an external device. The input/output unit 1340 may include at least one of an HDMI port, a component jack, a PC port, or a USB port.

The audio processing unit 1370 may perform processing on audio data. The audio processing unit 1370 may perform various processing, such as decoding, amplification, noise removal, and noise canceling, on the audio data.

The audio output unit 1380 may output, under control by the processor 1301, audio included in content received through the tuner unit 1310, audio input through the communicator 1320 or the input/output unit 1340, and audio stored in the memory 1302. The audio output unit 1380 may include at least one of a speaker, a headphone, or a Sony/Philips digital interface (S/PDIF) (output terminal).

The input interface 1390 may receive a user input to control the display device 1300. The input interface 1390 may include various types of user input devices, including a touch panel that detects a user's touch, a button that receives a user's push operation, a wheel that receives a user's rotation operation, a keyboard, a dome switch, a microphone for voice recognition, and a motion detection sensor that senses motion, but is not limited thereto.

According to an embodiment, a source device includes an image receiver; a communicator; at least one processor including processing circuitry; and memory including one or more storage media storing one or more instructions, The at least one processor according to an embodiment of the disclosure individually or collectively executes the one or more instructions to cause the source device to transmit first media data obtained through the image receiver to a display device through a first transmission path.

The at least one processor according to an embodiment of the disclosure individually or collectively executes the one or more instructions to cause the source device to convert, based on the first transmission path being lost, the first media data into second media data.

The at least one processor according to an embodiment of the disclosure individually or collectively executes the one or more instructions to cause the source device to store the second media data in a local web server.

The at least one processor according to an embodiment of the disclosure individually or collectively executes the one or more instructions to cause the source device to transmit, according to a request from the display device, the second media data stored in the local web server to the display device through a second transmission path that is different from the first transmission path.

The first transmission path according to an embodiment of the disclosure may include a path through which the first media data is transmitted via a first communication module that enables direct communication between the source device and the display device.

The second transmission path may include a path through which the second media data is transmitted via a second communication module that enables communication between the source device and the display device through a broadband network.

The first media data according to an embodiment of the disclosure may include data based on a first communication protocol that is a standard available in a broadcast network.

The second media data according to an embodiment of the disclosure may include data based on a second communication protocol that is a standard available in the broadband network.

The at least one processor according to an embodiment of the disclosure may individually or collectively execute the one or more instructions to cause the source device to extract, based on the first transmission path being lost, one or more media files included in the first media data standardized according to a first communication protocol.

The at least one processor according to an embodiment of the disclosure may individually or collectively execute the one or more instructions to cause the source device to generate the second media data by standardizing the one or more media files according to a second communication protocol that is different from the first communication protocol.

The second media data according to an embodiment of the disclosure may include one or more segments.

The at least one processor according to an embodiment of the disclosure may individually or collectively execute the one or more instructions to cause the source device to receive a segment request from the display device by using a URL including segment availability start time information and location information of the local web server.

The at least one processor according to an embodiment of the disclosure may individually or collectively execute the one or more instructions to cause the source device to transmit, in response to the segment request, a segment corresponding to the segment availability start time information, from among the one or more segments, to the display device through the second transmission path.

The segment availability start time information according to an embodiment of the disclosure may correspond to a time point when the first transmission path is lost.

The segment corresponding to the segment availability start time information, according to an embodiment of the disclosure, may correspond to a segment generated by the source device at the time point when the first transmission path is lost.

The at least one processor according to an embodiment of the disclosure may individually or collectively execute the one or more instructions to cause the source device to transmit, based on the first transmission path being recovered, the first media data to the display device through the first transmission path.

A display device according to an embodiment of the disclosure includes a communicator, at least one processor, and memory including one or more storage media storing one or more instructions.

The at least one processor according to an embodiment of the disclosure individually or collectively executes the one or more instructions to cause the display device to receive first media data from a source device through a first transmission path.

The at least one processor according to an embodiment of the disclosure individually or collectively executes the one or more instructions to cause the display device to obtain, based on the first transmission path being lost, second media metadata for accessing second media data.

The at least one processor according to an embodiment of the disclosure individually or collectively executes the one or more instructions to cause the display device to request, based on the second media metadata, the second media data from the source device.

The at least one processor according to an embodiment of the disclosure individually or collectively executes the one or more instructions to cause the display device to receive the second media data from the source device through a second transmission path that is different from the first transmission path.

The first transmission path according to an embodiment of the disclosure may include a path through which the first media data is received via a first communication module comprising communication circuitry that enables direct communication between the source device and the display device.

The second transmission path may include a path through which the second media data is received via a second communication module comprising communication circuitry that enables communication between the source device and the display device through a broadband network.

The first media data according to an embodiment of the disclosure may include data based on a first communication protocol that is a standard available in a broadcast network.

The second media data according to an embodiment of the disclosure may include data based on a second communication protocol that is a standard available in the broadband network.

The at least one processor according to an embodiment of the disclosure may individually or collectively execute the one or more instructions to cause the display device to generate the second media metadata including location information of a local web server of the source device and segment availability start time information.

The second media data according to an embodiment of the disclosure may include one or more segments.

The at least one processor according to an embodiment of the disclosure may individually or collectively execute the one or more instructions to cause the display device to transmit a segment request to the source device by using a URL including the segment availability start time information and the location information of the local web server.

The at least one processor according to an embodiment of the disclosure may individually or collectively execute the one or more instructions to cause the display device to receive, in response to the segment request, a segment corresponding to the segment availability start time information from the source device through the second transmission path.

The segment availability start time information according to an embodiment of the disclosure may correspond to a time point when the first transmission path is lost.

The segment corresponding to the segment availability start time information, according to an embodiment of the disclosure, may correspond to a segment stored in the local web server at the time point when the first transmission path is lost.

The at least one processor according to an embodiment of the disclosure may individually or collectively execute the one or more instructions to cause the display device to, based on receiving the first media data, extract a video stream by parsing a packet packetized according to a first communication protocol corresponding to the first media data.

The at least one processor according to an embodiment of the disclosure may individually or collectively execute the one or more instructions to cause the display device to, according to receiving the second media data, extract a video stream by parsing a packet packetized according to a second communication protocol corresponding to the second media data.

The at least one processor according to an embodiment of the disclosure may individually or collectively execute the one or more instructions to cause the display device to receive, based on the first transmission path being recovered, the first media data from the source device through the first transmission path.

An operating method of a source device according to an embodiment of the disclosure includes obtaining first media data through a tuner unit, transmitting the first media data to a display device through a first transmission path, converting, based on the first transmission path being lost, the first media data into second media data, storing the second media data in a local web server, and transmitting, according to a request from the display device, the second media data stored in the local web server to the display device through a second transmission path that is different from the first transmission path.

The converting of the first media data into the second media data, according to an embodiment of the disclosure, may include extracting, based on the first transmission path being lost, one or more media files included in the first media data standardized according to a first communication protocol, and generating the second media data by standardizing the one or more media files according to a second communication protocol that is different from the first communication protocol.

The second media data according to an embodiment of the disclosure may include one or more segments.

The transmitting of the second media data to the display device through the second transmission path, according to an embodiment of the disclosure, may include receiving a segment request from the display device by using a URL including segment availability start time information and location information of the local web server, and transmitting, in response to the segment request, a segment corresponding to the segment availability start time information, from among the one or more segments, to the display device through the second transmission path.

A machine-readable storage medium may be provided in the form of a non-transitory storage medium. Here, the term "non-transitory storage medium" refers to a tangible device and does not include a signal (e.g., electromagnetic waves). This term does not distinguish a case where data is stored in the storage medium semi-permanently and a case where the data is stored in the storage medium temporarily. For example, the "non-transitory storage medium" may include a buffer that temporarily stores data.

According to an embodiment of the disclosure, methods according to various embodiments of the disclosure may be provided by being included in a computer program product. The computer program product may be a commercial product that may be traded between a seller and a buyer. The computer program product may be distributed in the form of a computer-readable storage medium (e.g., a compact disc read-only memory (CD-ROM)), through an application store, directly between two user devices (e.g., smartphones), or online (e.g., downloaded or uploaded). In the case of online distribution, at least a part of the computer program product (e.g., a downloadable application) may be at least temporarily generated or temporarily stored in a machine-readable storage medium, such as a server of a manufacturer, a server of an application store, or a memory of a relay server.

What is claimed is:

1. A source device comprising:
an image receiver;
a communicator;
at least one processor comprising processing circuitry; and
memory comprising one or more storage media storing one or more instructions,
wherein the one or more instructions, when executed by the at least one processor individually or collectively, cause the source device to:
transmit first media data obtained through the image receiver to a display device through a first transmission path;
based on the first transmission path being lost, convert the first media data into second media data;
store the second media data in a local web server; and
transmit, based on a request received from the display device, the second media data stored in the local web server to the display device through a second transmission path that is different from the first transmission path.

2. The source device of claim 1, wherein the communicator comprises:
a first communication module comprising communication circuitry, configured to enable direct communication between the source device and the display device, and
a second communication module comprising communication circuitry, configured to enable communication between the source device and the display device through a broadband network,
wherein the first transmission path comprises a path through which the first media data is transmitted via the first communication module , and
wherein the second transmission path comprises a path through which the second media data is transmitted via the second communication module .

3. The source device of claim 2, wherein the first media data comprises data based on a first communication protocol that is a standard available in a broadcast network, and
wherein the second media data comprises data based on a second communication protocol that is a standard available in the broadband network.

4. The source device of claim 1, wherein the one or more instructions, when executed by the at least one processor individually or collectively, cause the source device to:
extract, based on the first transmission path being lost, one or more media files included in the first media data standardized according to a first communication protocol; and
generate the second media data by standardizing the one or more media files according to a second communication protocol that is different from the first communication protocol.

5. The source device of claim 1, wherein the second media data comprises one or more segments, and
wherein the one or more instructions, when executed by the at least one processor individually or collectively, cause the source device to:
obtain a segment request from the display device by using a uniform resource locator (URL) comprising segment availability start time information and location information of the local web server; and
transmit, based on the segment request, a segment corresponding to the segment availability start time information, from among the one or more segments, to the display device through the second transmission path.

6. The source device of claim 5, wherein the segment availability start time information corresponds to a time point when the first transmission path is lost, and
wherein the segment corresponding to the segment availability start time information corresponds to a segment generated by the source device at the time point when the first transmission path is lost.

7. The source device of claim 1, wherein the one or more instructions, when executed by the at least one processor individually or collectively, cause the source device to , based on the first transmission path being recovered, transmit the first media data to the display device through the first transmission path.

8. A display device comprising:
a communicator;
at least one processor comprising processing circuitry; and
memory comprising one or more storage media storing one or more instructions,
wherein the one or more instructions, when executed by the at least one processor individually or collectively, cause the display device to:
obtain first media data from a source device through a first transmission path;
based on the first transmission path being lost, obtain second media metadata for accessing second media data;
request, based on the second media metadata, the second media data from the source device; and
obtain the second media data from the source device through a second transmission path that is different from the first transmission path.

9. The display device of claim 8, wherein the communicator comprises:
a first communication module comprising communication circuitry,configured to enable direct communication between the source device and the display device, and
a second communication module comprising communication circuitry, configured to enable communication between the source device and the display device through a broadband network,
wherein the first transmission path comprises a path through which the first media data is obtained via the first communication module , and
wherein the second transmission path comprises a path through which the second media data is obtained via the second communication module .

10. The display device of claim 9, wherein the first media data comprises data based on a first communication protocol that is a standard available in a broadcast network, and
wherein the second media data comprises data based on a second communication protocol that is a standard available in the broadband network.

11. The display device of claim 8, wherein the one or more instructions, when executed by the at least one processor individually or collectively, cause the display device to generate the second media metadata comprising location information of a local web server of the source device and segment availability start time information.

12. The display device of claim 11, wherein the second media data comprises one or more segments, and
wherein the one or more instructions, when executed by the at least one processor individually or collectively, cause the display device to:
transmit a segment request to the source device by using a uniform resource locator (URL) comprising the segment availability start time information and the location information of the local web server; and
obtain, based on the segment request, a segment corresponding to the segment availability start time information from the source device through the second transmission path.

13. The display device of claim 12, wherein the segment availability start time information corresponds to a time point when the first transmission path is lost, and
wherein the segment corresponding to the segment availability start time information corresponds to a segment stored in the local web server at the time point when the first transmission path is lost.

14. The display device of claim 10, wherein the one or more instructions, when executed by the at least one processor individually or collectively, cause the display device to:
based on obtaining the first media data, extract a video stream by parsing a packet packetized according to the first communication protocol corresponding to the first media data; and
based on obtaining the second media data, extract a video stream by parsing a packet packetized according to the second communication protocol corresponding to the second media data.

15. The display device of claim 8, wherein the one or more instructions, when executed by the at least one processor individually or collectively, cause the display device to , based on the first transmission path being recovered, obtain the first media data from the source device through the first transmission path.

16. An operating method of a source device, the operating method comprising:
transmitting first media data obtained through an image receiver to a display device through a first transmission path;
based on the first transmission path being lost, converting the first media data into second media data;
storing the second media data in a local web server; and
transmitting, based to a request received from the display device, the second media data stored in the local web server to the display device through a second transmission path that is different from the first transmission path.

17. The operating method of claim 16, wherein the first transmission path comprises a path through which the first media data is transmitted via a first communication module of the source device configured to enable direct communication between the source device and the display device, and
wherein the second transmission path comprises a path through which the second media data is transmitted via a second communication module of the source device configured to enable communication between the source device and the display device through a broadband network.

18. The operating method of claim 16, wherein the converting the first media data into the second media data comprises:
extracting, based on the first transmission path being lost, one or more media files included in the first media data standardized according to a first communication protocol; and
generating the second media data by standardizing the one or more media files according to a second communication protocol that is different from the first communication protocol.

19. The operating method of claim 16, wherein the second media data comprises one or more segments, and
wherein the transmitting of the second media data to the display device (200) through the second transmission path comprises:
obtaining a segment request from the display device by using a uniform resource locator (URL) comprising segment availability start time information and location information of the local web server; and
transmitting, based on the segment request, a segment corresponding to the segment availability start time information, from among the one or more segments, to the display device through the second transmission path.

20. A non-transitory computer-readable recording medium having recorded thereon a program for performing, on a computer, an operating method of a source device, the operating method comprising:
transmitting first media data obtained through an image receiver to a display device through a first transmission path;
based on the first transmission path being lost, converting the first media data into second media data;
storing the second media data in a local web server; and
transmitting, based on a request from the display device, the second media data stored in the local web server to the display device through a second transmission path that is different from the first transmission path.
